(19) United States
(12) Patent Application Publication
(10) Pub. No.: US 2026/0101303 A1
(43) Pub. Date: Apr. 9, 2026

(54) POSITIONING USING RADIO FREQUENCY IDENTIFICATION (RFID) TAGS

(71) Applicant: QUALCOMM Incorporated, San Diego, CA (US)

(72) Inventors: Ahmed ELSHAFIE, San Diego, CA (US); Alexandros MANOLAKOS, Athens (GR); Yuchul KIM, San Diego, CA (US); Zhikun WU, Beijing (CN); Yu ZHANG, San Diego, CA (US); Jing JIANG, San Diego, CA (US); Peter GAAL, San Diego, CA (US); Wanshi CHEN, San Diego, CA (US); Juan MONTOJO, San Diego, CA (US); Krishna Kiran MUKKAVILLI, San Diego, CA (US); Tingfang JI, San Diego, CA (US); Bala RAMASAMY, San Marcos, CA (US); Danlu ZHANG, San Diego, CA (US)

(21) Appl. No.: 19/110,378

(22) PCT Filed: Sep. 13, 2023
(86) PCT No.: PCT/US2023/032649

§ 371 Date: Mar. 10, 2025

(30) Foreign Application Priority Data
Oct. 11, 2022 (GR) 20220100837

(51) Int. Cl. H04W 64/00; H04L 67/12

(52) U.S. Cl. CPC H04W 64/00; H04L 67/12

(57) ABSTRACT

Aspects presented herein may enable the position of a UE to be determined based on a plurality of passive IoT devices with known locations. In one aspect, a UE receives information from a plurality of IoT devices, where the information includes an ID of a corresponding IoT device in the plurality of IoT devices and a position change indication for the corresponding IoT device, where the position change indication indicates whether a position of the corresponding IoT device has changed, where each of the plurality of IoT devices is associated with a known location. The UE obtains a position of one or more of the UE or at least one other IoT device based on the information received from the plurality of IoT devices including the ID of the corresponding IoT device and the position change indication for the corresponding IoT device.

### CROSS-REFERENCE TO RELATED APPLICATION

This application claims the benefit of Greece Application No. 20220100837, entitled “POSITIONING USING RADIO FREQUENCY IDENTIFICATION (RFID) TAGS” and filed on Oct. 11, 2022, which is expressly incorporated by reference herein in its entirety.

### TECHNICAL FIELD

The present disclosure relates generally to communication systems, and more particularly, to a wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives information from a plurality of Internet of Things (IoT) devices, where the information includes an identification (ID) of a corresponding IoT device in the plurality of IoT devices and a position change indication for the corresponding IoT device, where the position change indication indicates whether a position of the corresponding IoT device has changed, where each of the plurality of IoT devices is associated with a known location. The apparatus obtains a position of one or more of the UE or at least one other IoT device based on the information received from the plurality of IoT devices including the ID of the corresponding IoT device and the position change indication for the corresponding IoT device.

In an aspect of the disclosure, a method, a computer-readable medium, and an apparatus are provided. The apparatus receives at least one signal from at least one of a user equipment (UE) or a network entity. The apparatus transmits information for at least one of the UE or the network entity using the at least one signal, where the information includes an identification (ID) of the IoT device and a position change indication for the IoT device, where the position change indication indicates whether a position of the IoT device has changed, where the IoT device is associated with a known location.

In an aspect of the disclosure, a method, a computer-readable medium, and an apparatus are provided. The apparatus receives a first indication from a UE to calculate a position of the UE, where the first indication is associated with information from a plurality of IoT devices, where the information includes an ID of a corresponding IoT device in the plurality of IoT devices and a position change indication for the corresponding IoT device, where the position change indication indicates whether a position of the corresponding IoT device has changed from an initial position, where each of the plurality of IoT devices is associated with a known location. The apparatus calculates the position of the UE or at least one other IoT device based on the information including the ID of the corresponding IoT device and the position change indication for the corresponding IoT device.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating examples of different types of Internet-of-Things (IoT) devices in accordance with various aspects of the present disclosure.

FIG. 6 is a diagram illustrating an example passive IoT device in accordance with various aspects of the present disclosure.

FIG. 7 is a diagram illustrating an example of a passive IoT device performing backscattering/reflection of signal with modulation in accordance with various aspects of the present disclosure.

FIG. 8A is a diagram illustrating an example power relationship between a radio frequency (RF) source, a radio frequency identification (RFID) tag, and an RFID reader device in accordance with various aspects of the present disclosure.

FIG. 8B is a diagram illustrating an example of a monostatic operation in accordance with various aspects of the present disclosure.

FIG. 9 is a diagram illustrating an example communication procedure between an RFID reader and an RFID tag in accordance with various aspects of the present disclosure.

FIG. 10 is a diagram 1000 illustrating an example communication between a UE and a set of RFID tags during a UE positioning session in accordance with various aspects of the present disclosure.

FIG. 11 is a communication flow illustrating an example signaling between a server, an RFID reader and an RFID tag in accordance with various aspects of the present disclosure.

FIG. 12 is a communication flow illustrating an example signaling between a server, an RFID reader and an RFID tag in accordance with various aspects of the present disclosure.

FIG. 13 is a communication flow illustrating an example signaling between a server, an RFID reader and an RFID tag in accordance with various aspects of the present disclosure.

FIG. 14 is a flowchart of a method of wireless communication.

FIG. 15 is a diagram illustrating an example of a hardware implementation for an example apparatus and/or network entity.

FIG. 16 is a flowchart of a method of wireless communication.

FIG. 17 is a diagram illustrating an example of a hardware implementation for an example apparatus and/or network entity.

FIG. 18 is a flowchart of a method of wireless communication.

FIG. 19 is a diagram illustrating an example of a hardware implementation for an example apparatus and/or network entity.

### DETAILED DESCRIPTION

Aspects presented herein may enable the position of a UE to be determined based on a plurality of passive IoT devices with known locations. For example, in one aspect, if a UE is surrounded by multiple passive IoT devices (e.g., RFID tags) with known locations, the UE may be able to determine its location or its location relative to one or more passive IoT devices (or one or more known-location devices) based on performing positioning measurements (e.g., time-of-arrival (ToA), angle-of-arrival (AoA), round trip time (RTT), and/or other positioning related measurements, etc.) for signals (e.g., backscattered signals, configured reference signals, etc.) transmitted from the passive IoT devices. In another aspect, each of the passive IoT devices (or the IDs of the passive IoT devices) may be associated with a certain position/location in a database or a positioning server. Thus, if a UE has access to that database/positioning server, the UE may obtain the position/location of the passive IoT devices from the database/positioning server (e.g., based on the IDs o the passive IoT devices). In another aspect, to improve the positioning accuracy, the UE may also be configured to determine whether a passive IoT device has changed its position/location, and the UE may use passive IoT devices that have not changed position/location for the UE positioning, and may refrain from using passive IoT devices that have changed position/location for the UE positioning.

Aspects presented herein also provide various features that facilitate accurate positioning of a UE based on passive IoT devices. For example, in one aspect, signaling related to passive IoT devices with motion detector(s), passive IoT devices without motion detector(s), and passive IoT devices with the capability to determine their new locations and/or indicate their new locations are also provided to improve the positioning of the UE. For example, an RFID reader (e.g., with the assistance from an RF source or a network entity/node to send a continuous wave (CW) or signal that will be backscattered by the passive IoT devices) or an RF source (e.g., with the assistance from an RFID reader or a network entity/node, or it is doing both sourcing and reading if it is a FD device) that is configured to determine its position may send a signal to surrounding passive IoT devices. In response, the passive IoT devices may respond to the RFID reader or the RF source regarding their motion detection capabilities, whether their positions have changed, and/or their new locations, etc. Then, the RFID reader or the RF source may discard reading(s) from passive IoT device(s) that have changed position (note RFID reader may not know which passive IoT devices are surrounding it). In another aspect, a passive IoT device may also transmit its measurements to an RFID reader, such as by including motion detection metrics as a digital payload in the backscattered signal, or embedded/modulated them in the backscattered signal. In response, the RFID reader or another entity (e.g., a network entity/node) may determine whether the passive IoT device has changed position based on the motion detection metrics provided by the passive IoT device (discussed below).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

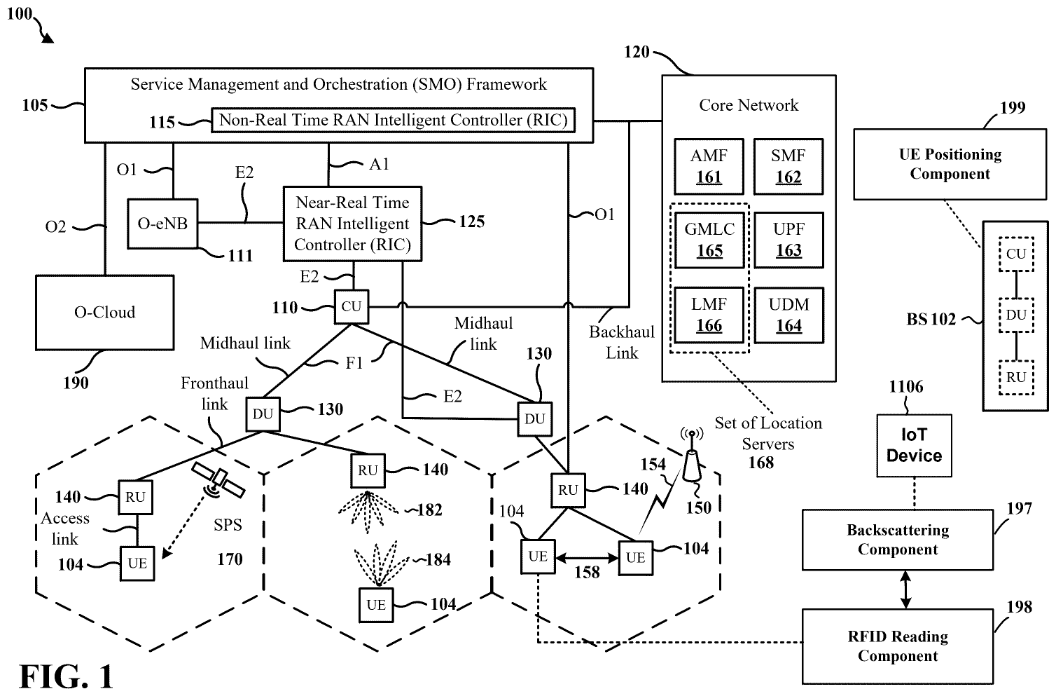

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RA configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to receive information from a plurality of IoT devices, where the information includes an ID of a corresponding IoT device in the plurality of IoT devices and a position change indication for the corresponding IoT device, where the position change indication indicates whether a position of the corresponding IoT device has changed, where each of the plurality of IoT devices is associated with a known location; and obtain a position of one or more of the UE or at least one other IoT device based on the information received from the plurality of IoT devices including the ID of the corresponding IoT device and the position change indication for the corresponding IoT device (e.g., via the RFID reading component 198).

In certain aspects, the base station 102 may be configured to receive a first indication from a UE to calculate a position of the UE, where the first indication is associated with information from a plurality of IoT devices, where the information includes an ID of a corresponding IoT device in the plurality of IoT devices and a position change indication for the corresponding IoT device, where the position change indication indicates whether a position of the corresponding IoT device has changed from an initial position, where each of the plurality of IoT devices is associated with a known location; and calculate the position of the UE or at least one other IoT device based on the information including the ID of the corresponding IoT device and the position change indication for the corresponding IoT device (e.g., via the UE positioning component 199).

In certain aspects, the RFID tag 1106 (e.g., an IoT device) may be configured to receive at least one signal from at least one of a UE or a network entity; and transmit information for at least one of the UE or the network entity using the at least one signal, where the information includes an ID of the IoT device and a position change indication for the IoT device, where the position change indication indicates whether a position of the IoT device has changed, where the IoT device is associated with a known location (e.g., via the backscattering component 197).

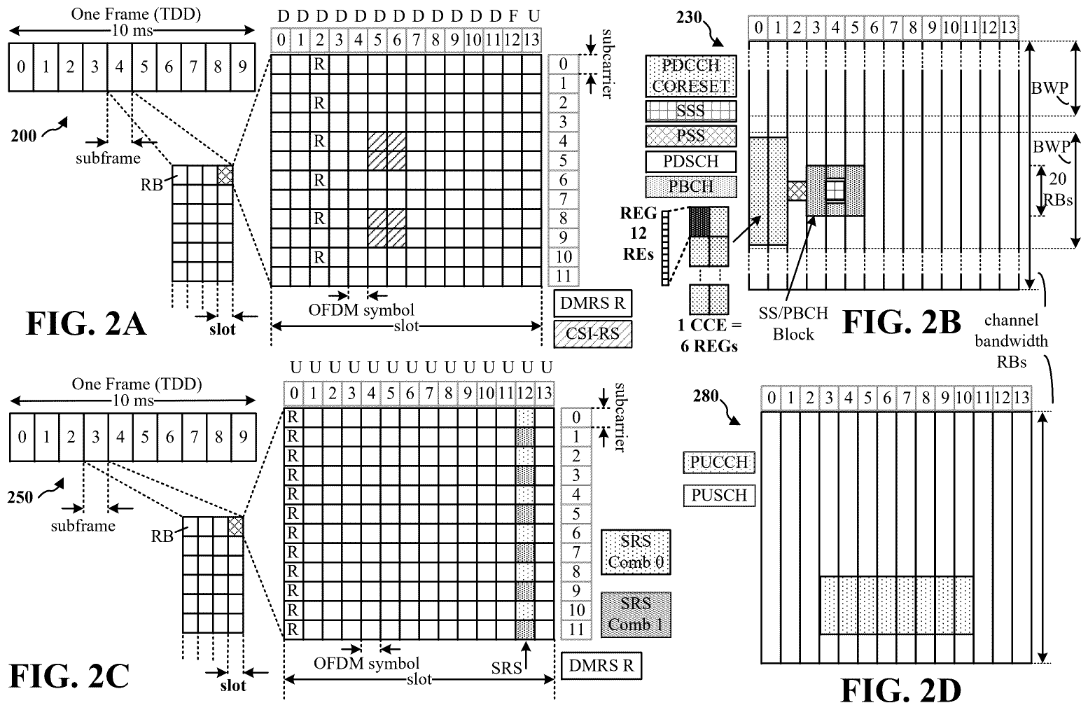

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ} *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

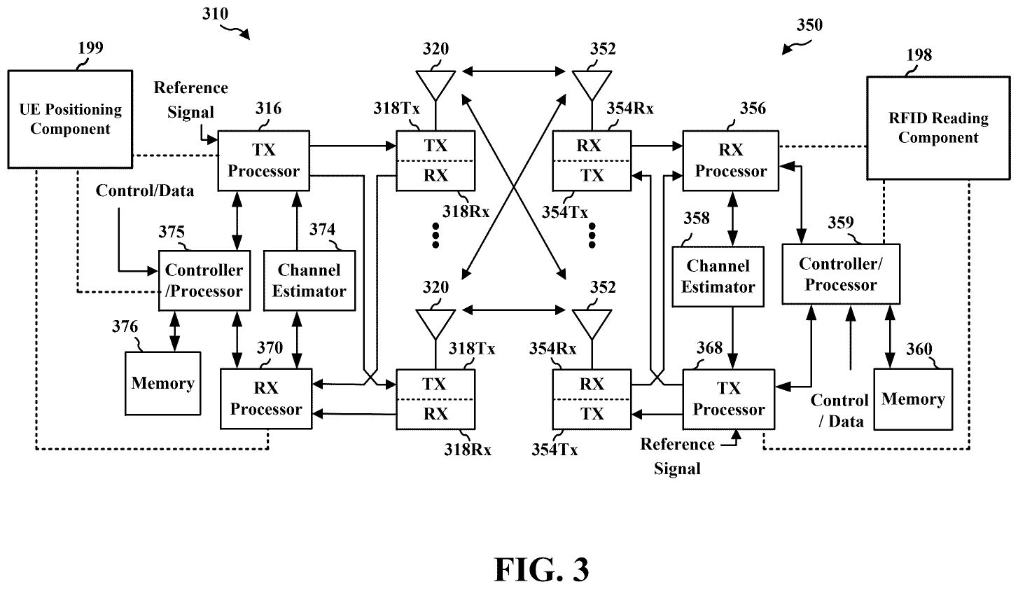

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RFID reading component 198 of FIG. 1.

At least one of the TX processor 316, the RX processor 370, and the controller/processor 375 may be configured to perform aspects in connection with the UE positioning component 199 of FIG. 1.

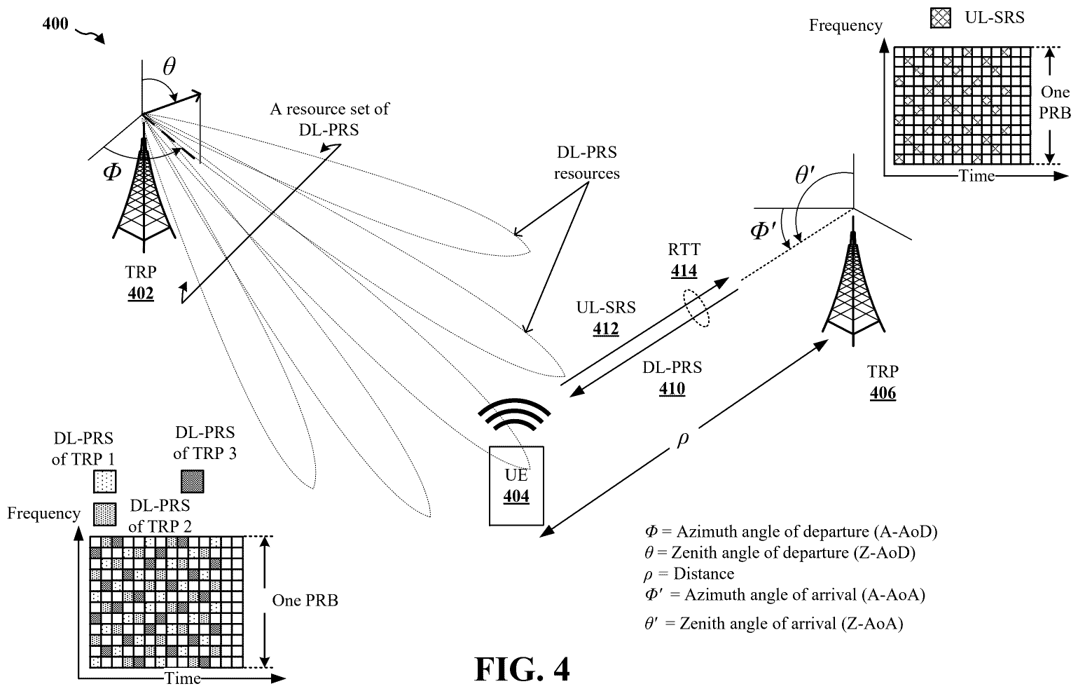

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance to certainty, supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

In some scenarios, the position or the relative position/distance of a wireless device may be determined based on measuring signals backscattered/reflected from a set of Internet-of-Things (IoT) devices. For example, the wireless device (or another wireless device) may transmit signals to the set of IoT devices, and the wireless device may receive signals reflected/backscattered (which may be referred to as “backscattered signal(s)” hereafter) from the set of IoT devices and measure the received backscattered signal(s). For example, the wireless device may measure the round-trip time (RTT), the time of arrival (ToA), the angle of arrival (AoA), and other positioning related measurements described in connection with FIG. 4, etc., of the backscattered signal(s) (which may collectively be referred to as “positioning measurements” hereafter). Based on the positioning measurements for the backscattered signals, the position and/or distance of the first wireless device with respect to one or more IoT devices may be calculated, estimated, and/or determined (e.g., by the first wireless device itself or another entity). A relative position of a wireless device my refer to the position of the wireless device with respect to another device or entity, such as an IoT device (e.g., the wireless device is 10 meters from the IoT device, the wireless device is cast of the IoT device, etc.). In some examples, the wireless device may be referred to as a backscatter receiver, a backscatter reader, an RFID reader, an RFID reader UE, and/or a reader UE. The IoT device may be referred to as a passive IoT device, a radio frequency identification (RFID) tag (or simply a tag), a backscatter-based IoT, or a backscatter-based RFID. RFID may refer to a form of wireless communication that incorporates the use of electromagnetic or electrostatic coupling in the radio frequency portion of the electromagnetic spectrum to uniquely identify an object, an animal or a person, etc. In addition, the wireless device that transmits signals to the IoT devices may be referred to as an RF source, an RF source UE, or a carrier emitter. Note a wireless device may be capable of both transmitting signals to passive IoT devices and receiving reflected signals (e.g., readings) from passive IoT devices, which may be referred to as full-duplex devices (discussed below). As such, an RF source may also be an RFID reader and vice versa. For purposes of the present disclosure, an IoT device may refer to a device that is capable of wirelessly connecting to a network and have the ability to transmit data.

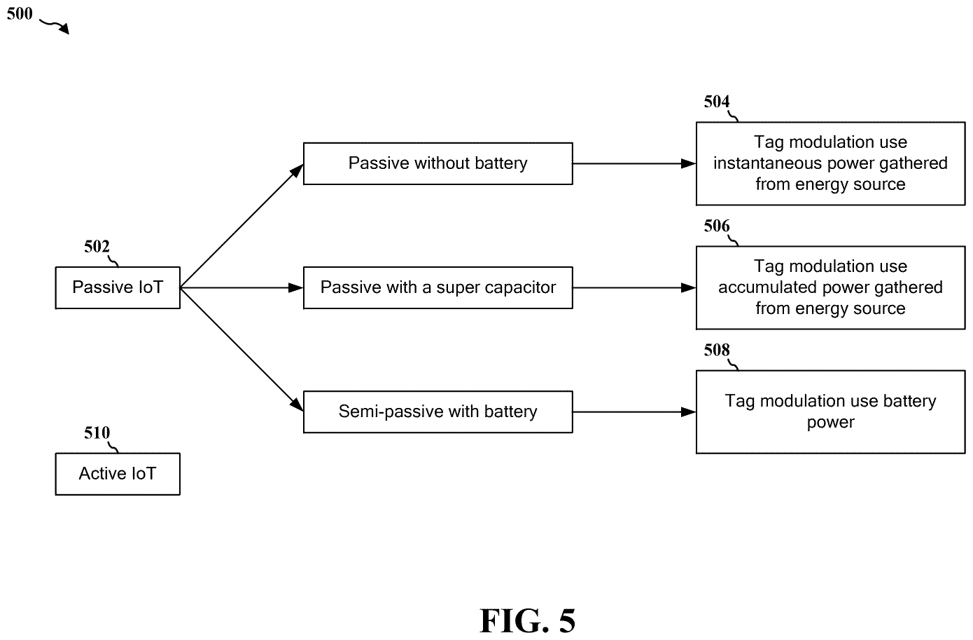

FIG. 5 is a diagram 500 illustrating examples of different types of IoT devices (e.g., RFID tags) in accordance with various aspects of the present disclosure. An IoT device may be configured to be a passive device or an active device. For example, as shown at 504, a passive IoT device 502 may be a device that does not have a battery in its terminal, but its terminal may accumulate (e.g., absorb or harvest) the energy from radio signaling (e.g., from a base station, an RF source, a wireless device, a UE, etc.). In another example, as shown at 506, the passive IoT device 502 may include a super capacitor, where the terminal of the passive IoT device 502 may also accumulate energy from other source(s) of energy, such as solar, wind, thermoelectric, etc., as supplement. In another example, as shown at 508, the passive IoT device 502 may be configured to be semi-passive with a battery, which may enable the passive IoT device 502 to modulate signals using the power from the battery, and the passive IoT device 502 may be able to activate almost all the time but may not transmit actively. For a passive IoT device, a user may connect to it and receive information from it. On the other hand, an active IoT device 510 may be a device that transmits information as a timed, a threshold, and/or a constant stream. For example, an active IoT device or a semi-active IoT device may include an amplification capability and/or active RF components, which may enable the IoT device to transmit better quality transmission/information.

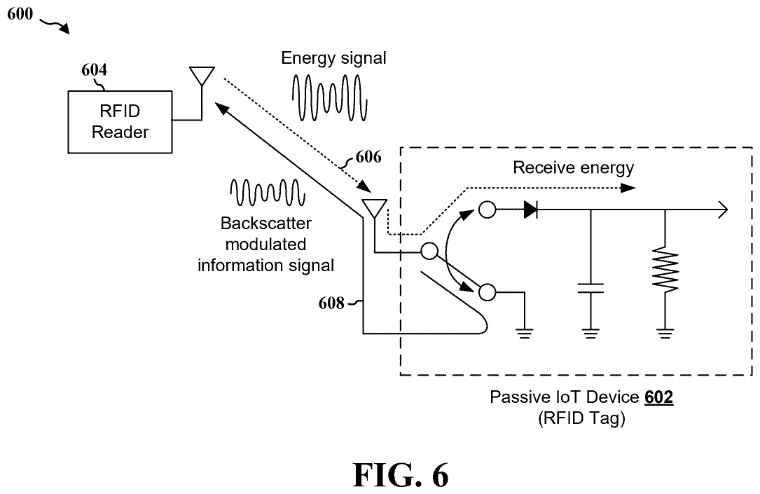

FIG. 6 is a diagram 600 illustrating an example passive IoT device in accordance with various aspects of the present disclosure. A passive IoT device 602 (e.g., an RFID tag) may include small transponder(s) emitting an information-bearing signal upon receiving a signal (e.g., from an RFID reader 604). The passive IoT device 602 may operate without a battery at a low operating expense (OPEX), at a low maintenance cost, and/or with a long-life circle. As shown at 606, the passive IoT device 602 may absorb/harvest energy over the air based on the energy signal transmitted from the RFID reader 604 to power its transmission/reception circuitry. Then, as shown at 608, the passive IoT device 602 may use the absorbed/harvested energy to transmit (e.g., reflect/backscatter) an information signal (e.g., a signal that contains information, a 1-bit indication, a multi-bit indication, etc.), where the transmitted information signal may be typically backscatter modulated (e.g., modulated based on the signals received form the RFID reader 604). In some examples, the passive IoT device 602 may have a coverage of 20-30 meters in an indoor environment, and a coverage of 100-200 meters at an outdoor environment. The power consumption for the passive IoT device 602 may be within 0.1 milliwatt (mW) with a positioning accuracy between 3 to 5 meters and a date rate of 10-100 kilobyte per second (kpbs). The passive IoT device 602 may also be configured to use both licensed and unlicensed bands.

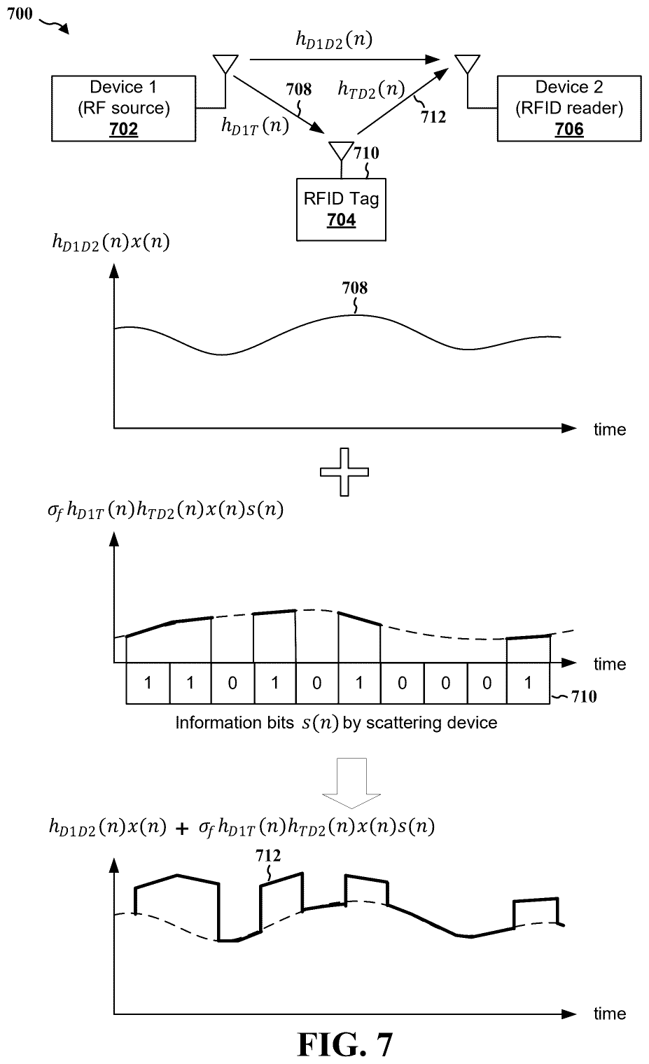

FIG. 7 is a diagram 700 illustrating an example of a passive IoT device (e.g., an RFID tag) performing backscattering/reflection of signal with modulation in accordance with various aspects of the present disclosure. In one example, one of the major information modulation methods used by a passive IoT device (e.g., an RFID tag 704) may be amplitude shift keying (ASK), where the passive IoT device may be configured to switch on the reflection when transmitting information bit ‘1’ and switch off the reflection when transmitting information bit ‘0’.

For example, as shown at 708, a first device 702 (e.g., an RF source, a first UE or a network entity that is capable of transmitting RF waves) may transmit a certain radio wave denoted as x(n), which is to be received by an RFID tag 704 (e.g., a passive IoT device, an RFID reader, etc.). As shown at 710, the information bits of the RFID tag 704 may be denoted as s(n)∈{0,1}. Then, as shown at 712, the received signal y(n) at a second device (e.g., a second UE, an RF reader, etc.) may be denoted by y(n)=(h_{D1D2}(n)+σ_{f}h_{D1T}(n)h_{TD2}(n)s(n))x(n)+noise. Note the first device 702 and the second device 706 may also be the same device, which may be referred to as a full-duplex device). In one example, when s(n)=0, the RFID tag 704 may be configured to switch off the reflection (e.g., the RFID tag 704 does not transmit any signal), such that the second device 706 may just receive a direct link signal from the first device 702 (e.g., y(n)=h_{D1D2}(n)x(n)+noise). However, when s(n)=1, the RFID tag 704 may be configured to switch on the reflection, such that the second device 706 may receive a superposition of both the direct link signal and the backscatter link signal (e.g., y(n)=(h_{D1D2}(n)+σ_{f}h_{D1T}(n)h_{TD2}(n)s(n))x(n)+noise, such as shown at 712, where of may denote the reflection coefficient).

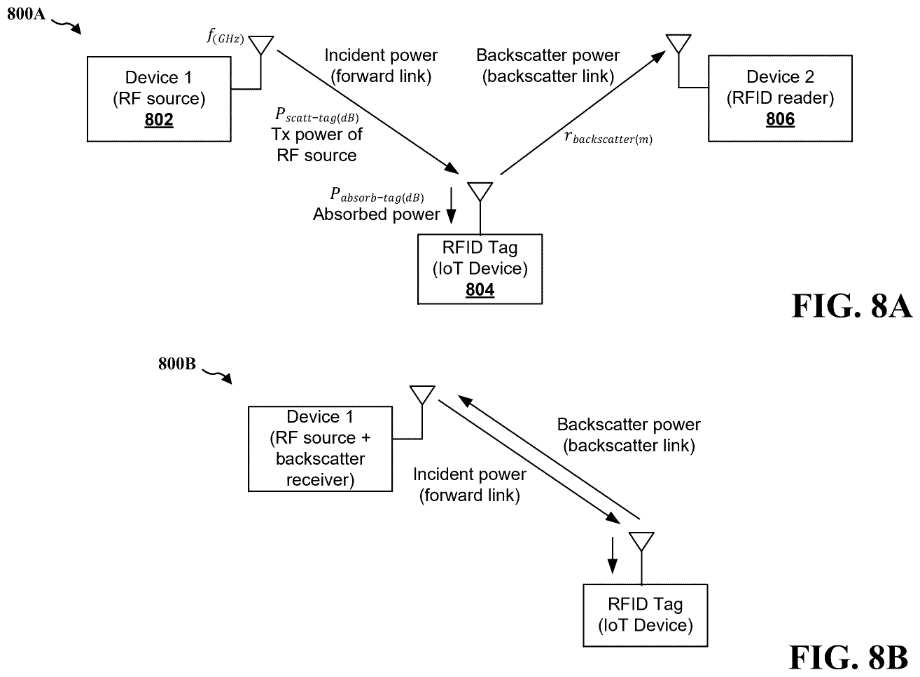

FIG. 8A is a diagram 800A illustrating an example power relationship between an RF source, an RFID tag, and an RFID reader device in accordance with various aspects of the present disclosure. In some examples, the reading of information from an RFID tag, such as described in connection with FIG. 7, may be based on a bistatic operation, where the device transmitting the RF source to the RFID tag may be different from the device reading the information transmitted from the RF ID tag (e.g., the RF source and the RFID reader are different entities). For example, as shown by the diagram 800A, a first device 802 (e.g., an RF source) may transmit a signal to an RFID tag 804, where the signal may be transmitted with a transmission (Tx) power P_{scatt-tag(dB)} (e.g., Tx power of RF source, which may also be referred to as an incident power) and the link/path in which the signal is transmitted from the first device 802 to the RFID tag 804 may be referred to as a forward link. The power of the signal received by the RFID tag 804 may be referred to as an absorbed power and denoted by P_{absorb-tag(dB)}.

After the RFID tag 804 receives the signal from the first device 802, the RFID tag 804 may absorb (or harvest) power energy from the signal, modulate the signal, and then transmit the modulated signal to a second device 806 (e.g., an RFID reader), such as described in connection with FIG. 7. The link/path in which the modulated power signal is transmitted from the RFID tag 804 to the second device 806 may be referred to as a backscatter link, and the power of the modulated signal transmitted from the RFID tag 804 may be referred to as a backscatter power and denoted by P_{tag-scatt(dB)}.

In one example, if the RFID tag 804 is able to modulate the signal received from the first device 802 without any energy loss (e.g., in an idealized situation), then the power absorbed by the RFID tag 804 and used for transmission may equal to the power of the signal transmitted by the first device 802 (e.g., P_{scatt-tag(dB)}=P_{absorb-tag(dB)}=P_{tag-scatt(dB)}). However, in most scenarios (e.g., in a practical situation), the RFID tag 804 is likely to receive and modulate the signal from the first device 802 with some energy loss. For example, there may be an energy loss associated with the efficiency of the signal modulation at the RFID tag 804 (e.g., higher power loss when the modulation efficiency is low), which may be denoted by M_{loss(dB)}. As such, the power of the signal transmitted from the RFID tag 804 may equal to the power absorbed by the RFID tag 804 minus the energy loss (e.g., P_{scatt-tag(dB)}=P_{absorb-tag(dB)}−M_{loss(dB)}). After the signal is modulated by the RFID tag 804 and transmitted to the second device 806, the power of the modulated signal received at the second device 806 (e.g., denoted by P_{RX-reader(dB)}) may vary based on one or more conditions, such as the antenna transmit gain (G_{TX-tag(dB)}) at the RFID tag 804, the antenna reception gain G_{RX-reader(dB)} at the second device 806, and/or the distance of the backscatter link (i.e., distance between the RFID tag 804 and the second device 806), etc. For example, the power of the modulated signal received at the second device 806 (e.g., P_{RX-reader(dB)}) may be calculated based on:

$${P}_{R X - reader ( dB )} = {P}_{scatt - tag ( dB )} + {G}_{TX - tag ( dB )} + {G}_{RX - r e a der ( dB )} - 20 {log}_{10} {f}_{( G H z )} - 20 {log}_{I 0} {r}_{backscatter ( m )} - 32.44 dB ,$$

where f_{(GHZ)} may be the frequency in which the signal is transmitted from the first device 802. For the second device 806 to receive the modulated signal from the RFID tag 804, the power of the modulated signal received at the second device 806 is expected to exceed its sensitivity (e.g., P_{RX-reader(dB)}>sensitivity, which may indicate a minimum power of a signal that can be detected/received by the second device 806).

In some scenarios, the reading of information from an RFID tag may also be based on a monostatic operation, where the device transmitting the RF source to the RFID tag may also be used for reading the information transmitted from the RF ID tag (e.g., the RF source transmitter and backscatter receiver are co-located), such as shown by a diagram 800B of FIG. 8B. In some examples, such device may also be referred to as a full-duplex (FD) device, a FD reader, or a FD UE. The power relationship between an FD device and an RFID tag under the monostatic operation may be similar to the power relationship between an RF source, a backscatter receiver, and an RFID tag under the bistatic operation described in connection with FIG. 8A.

For purposes of the present disclosure, in some scenarios, an RF source may be a UE that is configured to determine its position, and an RFID reader may be one of: a network node/entity (e.g., a relay node, a RAN node, a non-RAN node, an IAB node, a base station, a component of a base station, etc.), the UE itself (e.g., if the UE is a full-duplex device capable of providing both RF sourcing and RFID reading as shown by the first device in FIG. 8B), or another UE that assists the RF source UE (e.g., just a RFID reader UE as shown by the second device 806 in FIG. 8A).

In another scenario, the RFID reader may be a UE that is configured to determine its position, then the RF source (e.g., the entity that provides the RF signal to assist the RFID reader) may be one of: a network node/entity (e.g., a relay node, a RAN node, a non-RAN node, an IAB node, a base station, a component of a base station, etc.), the UE itself (e.g., if the UE is a full-duplex device capable of providing both RF sourcing and RFID reading as shown by the first device in FIG. 8B), or another UE that assists the RFID reader (e.g., just an RF source UE as shown by the first device 802 in FIG. 8A).

In another scenario, the first device 802 and the second device 806 as shown on FIG. 8A or just a first device (e.g., a full-duplex device) as shown on FIG. 8B may be configured to find a position of one or more RFID tags, where the first device and/or second device may be one of: a UE, or a network node/entity (e.g., a relay node, a RAN node, a non-RAN node, an IAB node, a base station, a component of a base station, etc.).

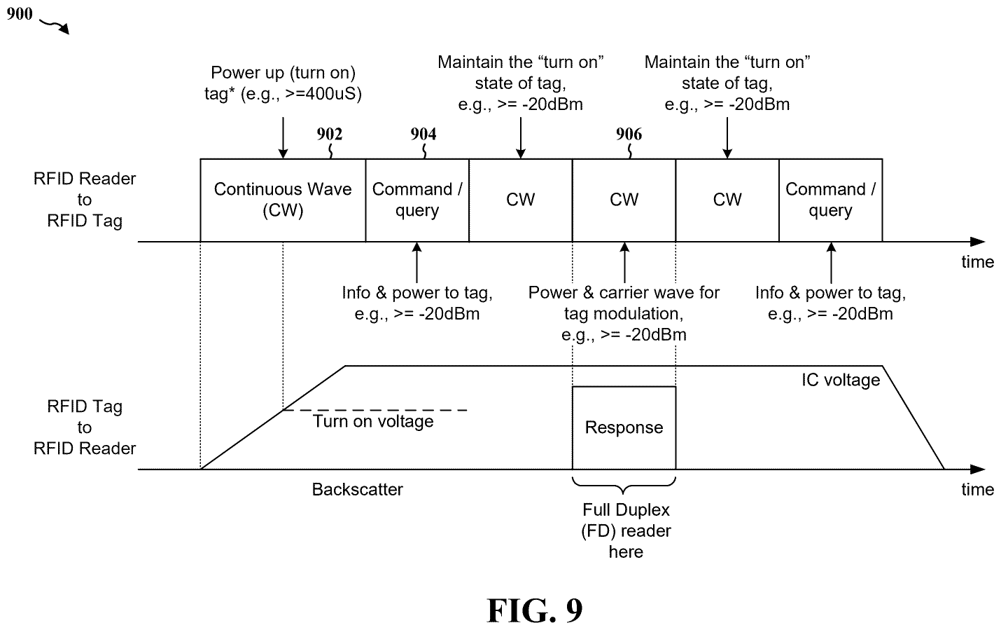

FIG. 9 is a diagram 900 illustrating an example communication procedure between an RFID reader and an RFID tag in accordance with various aspects of the present disclosure. As shown at 902, an RFID reader (which may be a FD device that is capable of providing RF source and read RFID) may transmit signals (e.g., continuous waves (CWs)) to an RFID tag, and the RFID tag may absorb/harvest power from the signals, such as described in connection with FIGS. 7 and 8A. In some scenarios, the RFID tag may have a turn-on voltage, where it may take a period of time for the RFID tag to absorb the power and to have sufficient power to transmit information (e.g., a modulated signal) or communicate with the RFID reader.

As shown at 904, after the RFID tag absorbs sufficient power and is turned on, the RFID reader may transmit a command or a query to the RFID tag (or the RFID tag may become able to receive a commend/query from the RFID reader). The RFID tag may continue to absorb power from the signals (e.g., from the CWs) transmitted by the RFID reader. Then, as shown at 906, in response to the command/query, the RFID tag may transmit information requested by the RFID reader (e.g., via a multi-bit indication) to the RFID reader, such as described in connection with FIG. 7. This process may continue and repeat until the RFID tag stops receiving signals from the RFID reader (e.g., the RFID tag is no longer able to absorb power).

Aspects presented herein may enable the position of a UE to be determined based on a plurality of passive IoT devices with known locations. For example, in one aspect, if a UE is surrounded by multiple passive IoT devices (e.g., RFID tags) with known locations, the UE may be able to determine its location or its location relative to one or more passive IoT devices (or one or more known-location devices) based on performing positioning measurements (e.g., ToA, AoA, RTT, and/or other positioning related measurements, etc.) for signals (e.g., backscattered signals, configured reference signals, etc.) transmitted from the passive IoT devices. In another aspect, each of the passive IoT devices (or the IDs of the passive IoT devices) may be associated with a certain position/location in a database or a positioning server. Thus, if a UE has access to that database/positioning server, the UE may obtain the position/location of the passive IoT devices from the database/positioning server (e.g., based on the IDs o the passive IoT devices). In another aspect, to improve the positioning accuracy, the UE may also be configured to determine whether a passive IoT device has changed its position/location, and the UE may use passive IoT devices that have not changed position/location for the UE positioning, and may refrain from using passive IoT devices that have changed position/location for the UE positioning.

Aspects presented herein also provide various features that facilitate accurate positioning of a UE based on passive IoT devices. For example, in one aspect, signaling related to passive IoT devices with motion detector(s), passive IoT devices without motion detector(s), and passive IoT devices with the capability to determine their new locations and/or indicate their new locations are also provided to improve the positioning of the UE. For example, an RFID reader (e.g., with the assistance from an RF source or a network entity/node to send a CW or signal that will be backscattered by the passive IoT devices) or an RF source (e.g., with the assistance from an RFID reader or a network entity/node, or it is doing both sourcing and reading if it is a FD device) that is configured to determine its position may send a signal to surrounding passive IoT devices. In response, the passive IoT devices may respond to the RFID reader or the RF source regarding their motion detection capabilities, whether their positions have changed, and/or their new locations, etc. Then, the RFID reader or the RF source may discard reading(s) from passive IoT device(s) that have changed position (note RFID reader may not know which passive IoT devices are surrounding it). In another aspect, a passive IoT device may also transmit its measurements to an RFID reader, such as by including motion detection metrics as a digital payload in the backscattered signal, or embedded/modulated them in the backscattered signal. In response, the RFID reader or another entity (e.g., a network entity/node) may determine whether the passive IoT device has changed position based on the motion detection metrics provided by the passive IoT device (discussed below).

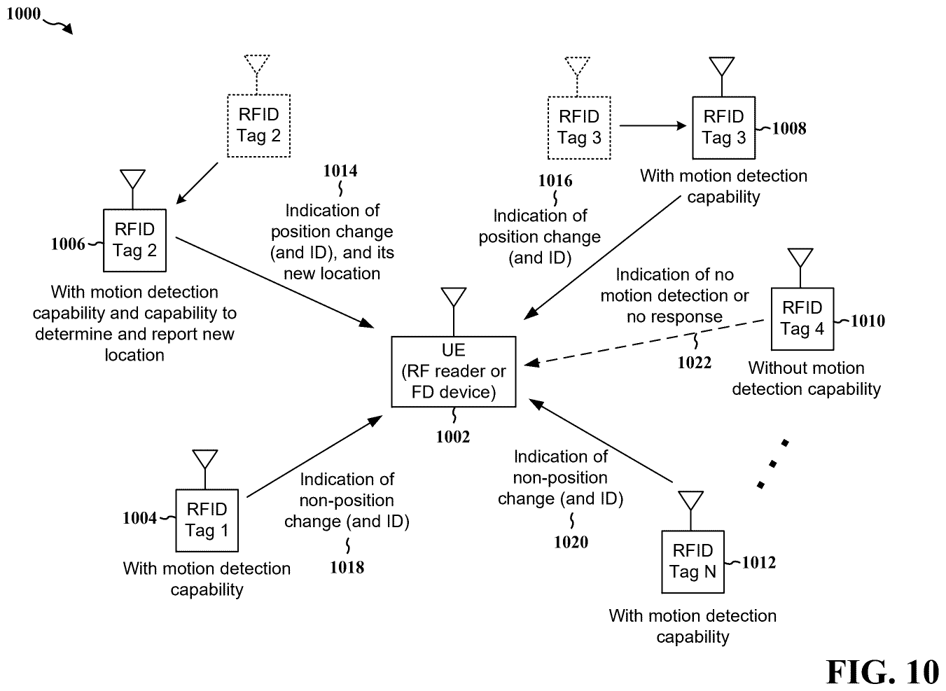

FIG. 10 is a diagram 1000 illustrating an example communication between a UE and a set of RFID tags during a UE positioning session in accordance with various aspects of the present disclosure. In one aspect of the present disclosure, an RFID tag (e.g., a passive IoT device) may include a motion detection capability (e.g., has at least one motion detection sensor), where the RFID tag may determine whether its position as changed based on motion detection or is able to generate/provide motion detection metrics via at least one motion detection sensor.

For example, a UE 1002, which may be an RF reader or an FD device, may be communicating with a set of RFID tags (e.g., reading information transmitted from the set of RFID tags), where the set of RFID tags may include a first RFID tag 1004, a second RFID tag 1006, a third RFID tag 1008, a fourth RFID tag 1010, and up to Nth RFID tag 1012. The UE 1002 may be communicating with the set of RFID tags for a UE positioning session, where the UE is configured to measure backscattered signals received from the set of RFID tags to determine its own location. The first RFID tag 1004, the second RFID tag 1006, the third RFID tag 1008, and the Nth RFID tag 1012 may have motion detection capabilities. In addition, the second RFID tag 1006 may further include a capability to determine its new location and to report its new location. On the other hand, the fourth RFID tag 1010 may not have a motion detection capability (e.g., does not have a motion detection sensor). Each RFID in the set of RFIDs may be associated with a corresponding identifier (ID), which may also be referred to as a tag-ID. For example, the first RFID tag 1004 may be associated with a first tag-ID, the second RFID tag 1006 may be associated with a second tag-ID, and the third RFID tag 1008 may be associated with a third tag-ID, etc. The tag-ID for an RFID tag may be configured to be unique and different from other RFID tags. Also, RFID tags with motion sensors, RFID tags with motion sensors and capability to determine and report new location, and/or RFID tags without motion sensors may be classified with different RFID tag classes, and be assigned with their corresponding RFID tag classes. As such, the UE 1002 may select or prioritize which RFID tags to use for the UE positioning based on their corresponding RFID tag class.

In one example, when an RFID tag detects motions or if the RFID tag determines that it has moved, the RFID tag may indicate to a reader UE that its position has changed (e.g., which may be validated based on last positioning information). For example, as shown at 1014 and 1016, based on their motion detection sensors and/or measurements obtained via their motion detection sensors, the second RFID tag 1006 and the third RFID tag 1008 may determine that their positions have changed, and they may transmit an indication (e.g., a position change indication, which indicates a change in the position/location of the RFID tag, such as from a last reading) to the UE 1002 (e.g., via a backscattered signal) indicating their position change. Similarly, if an RFID does not detect any motions or if the RFID determines that it has not moved, the RFID tag may indicate to a reader UE that its position has not changed (e.g., which may be also validated based on last positioning information). For example, as shown at 1018 and 1020, based on their motion detection sensors and/or measurements obtained via their motion detection sensors, the second RFID tag 1006 and the third RFID tag 1008 may determine that their positions have not changed, and they may transmit an indication to the UE 1002 (e.g., via a backscattered signal) indicating the non-position change. In addition, to enable determining the relative position of the UE 1002 with respect to the set of RFID tags, each RFID tag may include its corresponding tag-ID in the indication, such that the UE 1002 may determine the location of an RFID tag based on its corresponding tag-ID (e.g., obtained from a database or positioning server). In another example, an RFID tag may further indicate a timestamp associated with its last reading (or last transmission). For example, an RFID tag may indicate that the last time it determines whether it has moved in the indication. Based on the timestamp, the UE 1002 may determine whether to use the readings from that RFID tag (e.g., the UE 1002 may discard the reading of that RFID tag if the timestamp exceeds certain timing threshold).

In another example, an RFID tag may determine whether there is a motion or movement based on a kinetic energy harvesting, where a battery-free sensor on the RFID tag may be configured to detect a motion when the RFID tag is being moved. For example, a state variable of “motion detected” may be defined for an RFID tag to indicate its position change, which may be used for a future reporting, or for sending an indication/notice to an RFID reader or a network entity directly.

In one example, an RFID tag's capability to detect position change and/or to determine and report its new location may be shared with the UE 1002 as part of a response (e.g., via a capabilityInformation message) to a query from the UE 1002 or from a network entity/node (e.g., via a capabilityenquery message). In another example, an RFID tag's capability may be shared with the UE 1002 during an initial access procedure or discovery procedure by an RF source, an RFID reader, and/or a network entity (e.g., a base station). In some examples, the capability indication may be as simple as indicating just RFID tag class (and a specification or a predefined configuration may specify that what does each RFID tag class have as capabilities).

In another example, if an RFID tag does not have a capability to detect whether its position has changed (e.g., it does not have a motion detection sensor), the RFID tag may also transmit an indication indicating that it does not have such capability or the RFID tag may skip responding to the reader UE (e.g., the RFID tag may not reflect the signal). For example, as shown at 1022, as the fourth RFID tag 1010 does not have the motion detection capability, the fourth RFID tag 1010 may be configured to transmit an indication to the UE 1002 indicating that it doesn't have the capability to detect motion or position change, or be configured not to reflect signal to the UE 1002.

Based on the indications received from the set of RFID tags regarding whether their positions have changed, a reader UE may discard RFID tags (or skip readings from RFID tags) that have changed positions and if they do not know their new positions (e.g., did not include position or do not have them or if they cannot know their own position), and then the reader UE may use the remainder RFID tags for UE positioning. For example, after the UE 1002 receives an indication from the third RFID tag 1008 indicating that its position has changed and there is no new position information of the third RFID tag 1008, the UE 1002 may exclude/deprioritize the third RFID tag 1008 from the UE positioning session (e.g., by excluding its reading and measurements).

In another example, if an RFID tag is capable of detecting its current position, in some communication modes, the RFID tag may indicate there was a motion, and then the RFID tag may include/indicate the new positioning information to a reader UE. Then, the reader UE may use this new positioning information directly, among the input from other RFID tags, to determine its position (e.g., which may occur after accessing some other RFID tags' positions from the database). For example, as shown at 1014, the second RFID tag 1006 may include both the capability to detection motion and the capability to determine and report its current position. Thus, the second RFID tag 1006 may further indicate (e.g., via a backscattered signal) to the UE 1002 regarding its new position. Similarly, the capability signaling about having the ability to determine its position may also be configured to be part of RFID tag classes. For example, an RFID tag with the capability to determine its new position after movement may be classified in a different RFID tag class than an RFID tag without the capability to determine its new position after movement (e.g., the second RFID tag 1006 is in a different RFID tag class than the first RFID tag 1004).

In another example, if for privacy reasons where a reader UE (e.g., the UE 1002) does not have access to locations of the RFID tags directly, the reader UE may be configured to collect all IDs associated with the RFID tags and their new position reading/information from RFID tags (if available). Then, the reader UE 1002 may transmit the collected IDs (and the new position reading/information if available) to a server (e.g., a location server, an LMF, etc.) or a controller along with its own positioning readings/measurements (e.g., UE position related measurements such as RTT, AoA, AoD of backscattered signals from the RFID tags). In response, the server or the controller may determine the current position of the UE, and indicate the current position of the UE to the UE.

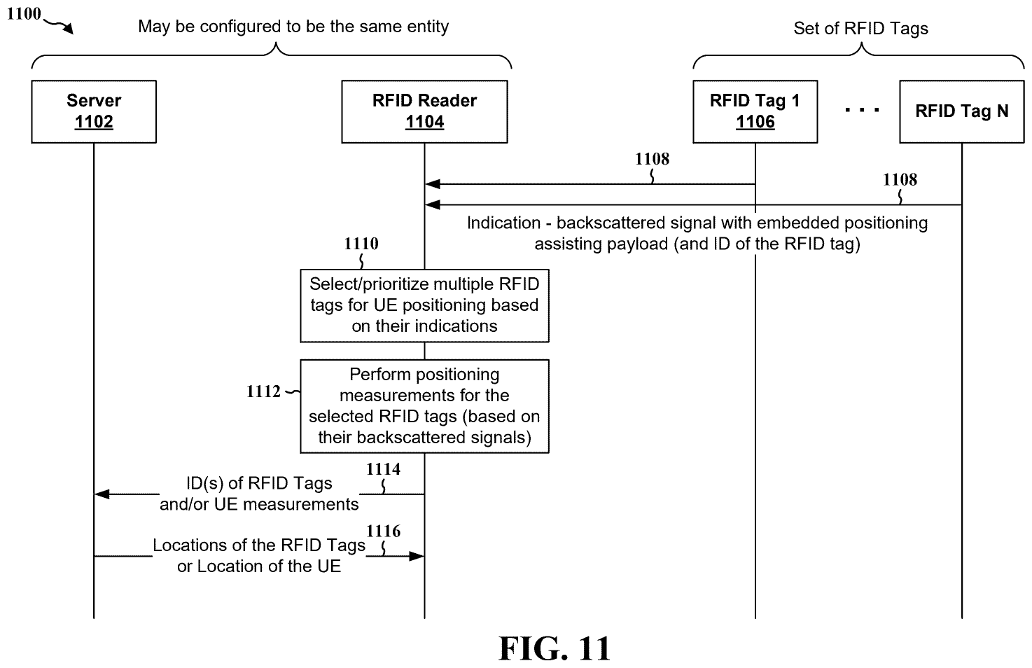

FIG. 11 is a communication flow 1100 illustrating an example signaling between a server, an RFID reader and an RFID tag in accordance with various aspects of the present disclosure. The numberings associated with the communication flow 1100 do not specify a particular temporal order and are merely used as references for the communication flow 1100.

In one example, an RFID reader 1104 (e.g., a UE, a network entity, an FD device, etc.) may be communicating with a set of RFID tags (a set of passive IoT devices), which may include a first RFID tag 1106 and up to Nth RFID tag, and the RFID reader 1104 may also be communicating with a server 1102 (e.g., a network entity such as a base station, a location server, or an LMF, etc.) for a UE positioning session (e.g., for determining the position of the UE or the position of the UE with respect to at least one RFID tag), such as described in connection with FIG. 10. In some examples, as described in connection with FIGS. 8A and 8B, the server 1102 may be an RF source, and/or the server 1102 and the RFID reader 1104 may be the same entity (e.g., a FD device with access to a database that provides locations of RFID tags based on their tag-IDs).

At 1108, the first RFID tag 1106 (and other RFID tags in the set of RFID tag) may transmit an indication (which may also be referred to as a tag report) to the RFID reader 1104 indicating at least one of: a motion detection indication capability, a positioning change indication, a new location determination capability, positioning information, an updated positioning information, and/or metrics associated with motion detections (which may also be referred to as motion detection metrics), such as described in connection with FIG. 10. The indication may be transmitted in a backscattered signal with an embedded positioning assisting payload, such as described in connection with FIGS. 7 and 9. In addition, the indication may further include a specific (positioning) ID that is associated with each RFID tag (e.g., a unique tag-ID). For example, the first RFID tag 1106 may include a unique ID corresponding to the first RFID tag 1106 in the indication/tag report.

As described in connection with FIG. 10, in some scenarios, instead of sending an indication of whether the position of the RFID tag has changed, an RFID tag may transmit motion detection metrics that are obtained via at least one motion detection sensor to the RFID reader. In response, the RFID reader or a server may determine whether the position of the RFID tag has changed based on the motion detection metrics provided by the RFID tag.

In one aspect, the motion detection metrics that may be included in the backscattered signals from the set of RFID tags may be received by the RFID reader 1104 across a determined time-domain window. The motion detection metrics may include an amplitude variation metric, a received signal strength (RSS) variation metric, a phase variation metric, a quantized channel Doppler response (e.g., multiple Doppler shifts with relative power of each Doppler shift), or a combination thereof. The motion detection metrics may be included as a digital payload in a backscattered signal, or embedded/modulated in the backscatter signal. In one example, after the RFID reader 1104 receives the motion detection metrics from the set of RFID tags, the RFID reader 1104 may evaluate the motions for the set of RFID tags (e.g., to determine whether the position of an RFID has changed based on its corresponding motion detection metrics). In another example, the RFID reader 1104 may transmit/forward the motion detection metrics received from the set of RFID tags to the server 1102, and the server 1102 may evaluate the motions for the set of RFID tags. In other examples, based on the motion detection metrics/measurements, an RFID tag may determine by its own if there was a motion or not, such as based on measuring reference signals from a transmitter. For example, the RFID tag may determine whether its position relative to a transmitter has changed based on measuring the reference signals transmitted from that transmitter periodically (e.g., the position of the RFID tag likely changed if the received power, direction, and/or angle of the reference signals have changed).

At 1110, after the RFID reader 1104 receives the indications from the set of RFID tags, the RFID reader 1104 may select/prioritize a plurality of RFID tags form the set of RFID tags to be used for the UE positioning session, such as based on their capabilities (e.g., obtained from their indications/tag reports), such as described in connection with FIG. 10. For example, the RFID reader 1104 may select the first RFID tag 1106 if the first RFID tag 1106 indicates that it has not moved or if the first RFID tag 1106 indicates its new position after a position change.

At 1112, after determining the plurality of RFID tags to be used for the UE positioning session, the RFID reader 1104 may perform positioning measurements for the selected RFID tags, such as measuring the RTT, the ToA, and/or the AoA of the backscattered signals from the plurality of RFID tags.

At 1114, for a network-based positioning (e.g., the server 1102 determines the location of the RFID reader 1104), the RFID reader 1104 may be configured to transmit the IDs of the plurality of RFID tags, the detected payload/backscattered signals embedded with information received from the plurality of RFID tags, and/or its positioning measurements to the server 1102. Then, at 1116, based on the IDs of the RFID tags, the information in the payload/backscattered signals, and/or the positioning measurements from the RFID reader 1104, the server 1102 may calculate/determine the position of the RFID reader 1104 (or relative position of the RFID reader 1104 with respect to one or more RFID tags), and the server 1102 may indicate the position/relative position of the RFID reader 1104 to the RFID reader 1104.

On the other hand, for a UE-based positioning (e.g., the RFID reader 1104 determines its own position), at 1114, the RFID reader 1104 may transmit just the IDs collected from the plurality of RFID tags to the server 1102, which may include the first RFID tag 1106. Then, at 1116, in response to the IDs of the plurality of RFID tags, the server 1102 may indicate the locations of the plurality of RFID tags to the RFID reader 1104. Based on the locations of the plurality RFID tags, the information in the payload/backscattered signals received from the plurality of RFID tags, and/or the positioning measurements performed by the RFID reader 1104, the RFID reader 1104 may calculate/determine its position or its position relative to one or more RFID tags.

In one example, the server 1102 may be configured to store the position of the RFID reader 1104 or the RFID tag(s) in a database. Then, the stored position of the RFID reader 1104 or the RFID tag(s) may be used for determining a second position of the RFID reader 1104 or the at least one other IoT device at a subsequent time (e.g., after a period of time or after the RFID reader 1104 moves).

In another example, the RFID reader 1104 and the server 1102 may be the same entity. For example, the RFID reader 1104 may be a FD device and have access to the locations of the plurality of RFID tags. As such, the RFID reader 1104 may determine the locations of the plurality of RFID tags without communicating with a separate entity. Also, if the RFID reader 1104 is an FD device, the RFID reader 1104 may also provide the incident powers or CWs to the set of RFID tags.

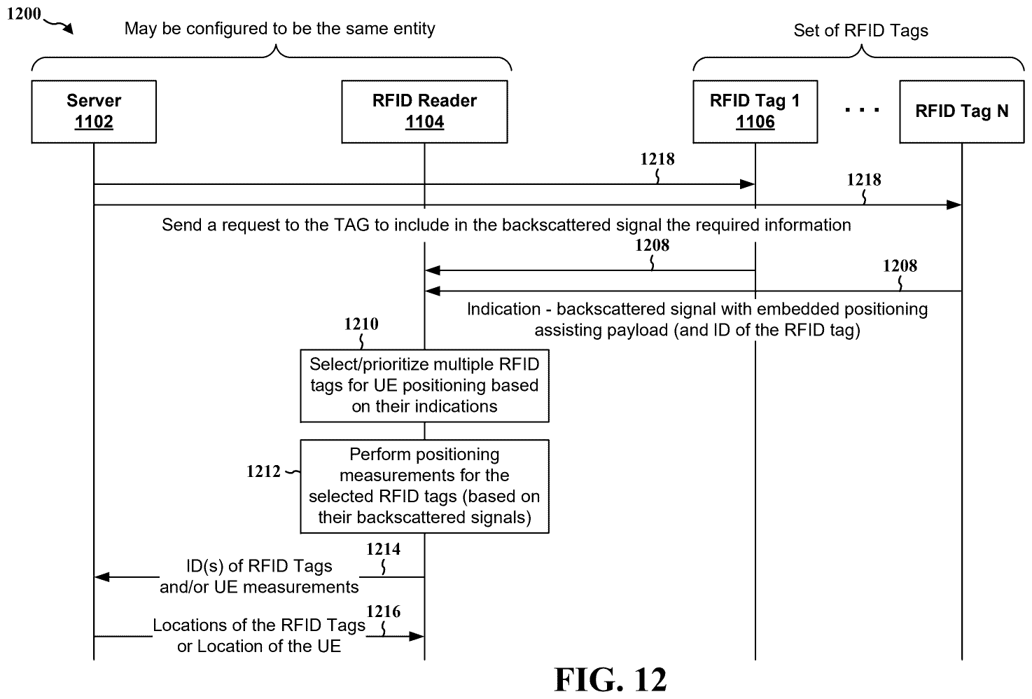

FIG. 12 is a communication flow 1200 illustrating an example signaling between a server, an RFID reader and an RFID tag in accordance with various aspects of the present disclosure. The numberings associated with the communication flow 1200 do not specify a particular temporal order and are merely used as references for the communication flow 1200.

In another configuration, as shown at 1218, a network entity may send a request to a set of RFID tags to initiate the procedures described in connection with FIGS. 11, such as to indicate at least one of: a motion detection indication capability, a positioning change indication, a new location determination capability, positioning information, an updated positioning information, and/or metrics associated with motion detections, etc., to an RFID reader (e.g., a UE which position is to be determined) via an indication or a tag report. The request from the network entity may be embedded in an incident signal (e.g., CWs from the server 1102) or in an explicit bit/signal. For example, a specific sequence may be included in the incident signal. In some examples, the request may further include timing information (e.g., the starting time for providing the indication) and/or the duration for providing the indication/tag report. As such, the RFID tags may transmit their indications/tag reports based on the timing information and/or the duration from the server 1102.

In another example, the request may further include a zone-ID, IDs associated with one or more RFID tags (which may be referred to as tag-ID(s)), and/or a location-ID. In response, RFID tags that are associated with the zone-ID, the tag-IDs indicated by the server 1102, and/or the location ID may transmit the indications to the RFID reader 1104. On the other hand, RFID tags that are not associated with the zone-ID, the tag-IDs indicated by the server 1102, and/or the location ID may skip or ignore transmitting the indications to the RFID reader 1104. Similarly, the network entity (e.g., the server 1102) and the RFID reader 1104 may be the same entity (e.g., a UE, an FD device, etc.).

Then, at 1208, RFID tags specified by the request from the server 1102, which may include the first RFID tag 1106, may transmit an indication or a tag report to the RFID reader 1104 indicating at least one of: a motion detection indication capability, a positioning change indication, a new location determination capability, positioning information, an updated positioning information, and/or metrics associated with motion detections, such as described in connection with FIGS. 10 and 11.

At 1210, after the RFID reader 1104 receives the indications from the set of RFID tags, the RFID reader 1104 may select/prioritize a plurality of RFID tags form the set of RFID tags to be used for the UE positioning session, such as based on their capabilities (e.g., obtained from their indications) as described in connection with FIGS. 10 and 11.

At 1212, after determining the plurality of RFID tags to be used for the UE positioning session, the RFID reader 1104 may perform positioning measurements for the selected RFID tags, such as measuring the RTT, the ToA, and/or the AoA of their backscattered signals.

At 1214, for a network-based positioning, the RFID reader 1104 may be configured to transmit the IDs of the plurality of RFID tags, the detected payload/backscattered signals embedded with information received from the plurality of RFID tags, and/or its positioning measurements to the server 1102. Then, at 1216, based on the IDs of the RFID tags, the information in the payload/backscattered signals, and/or the positioning measurements from the RFID reader 1104, the server 1102 may calculate/determine the position of the RFID reader 1104 (or relative position of the RFID reader 1104 with respect to one or more RFID tags), and the server 1102 may indicate the position/relative position of the RFID reader 1104 to the RFID reader 1104.

On the other hand, for a UE-based positioning, at 1214, the RFID reader 1104 may transmit just the IDs collected from the plurality of RFID tags to the server 1102, which may include the first RFID tag 1106. Then, at 1216, in response to the IDs of the plurality of RFID tags, the server 1102 may indicate the locations of the plurality of RFID tags to the RFID reader 1104. Based on the locations of the plurality RFID tags, the information in the payload/backscattered signals received from the plurality of RFID tags, and/or the positioning measurements performed by the RFID reader 1104, the RFID reader 1104 may calculate/determine its position or its position relative to one or more RFID tags.

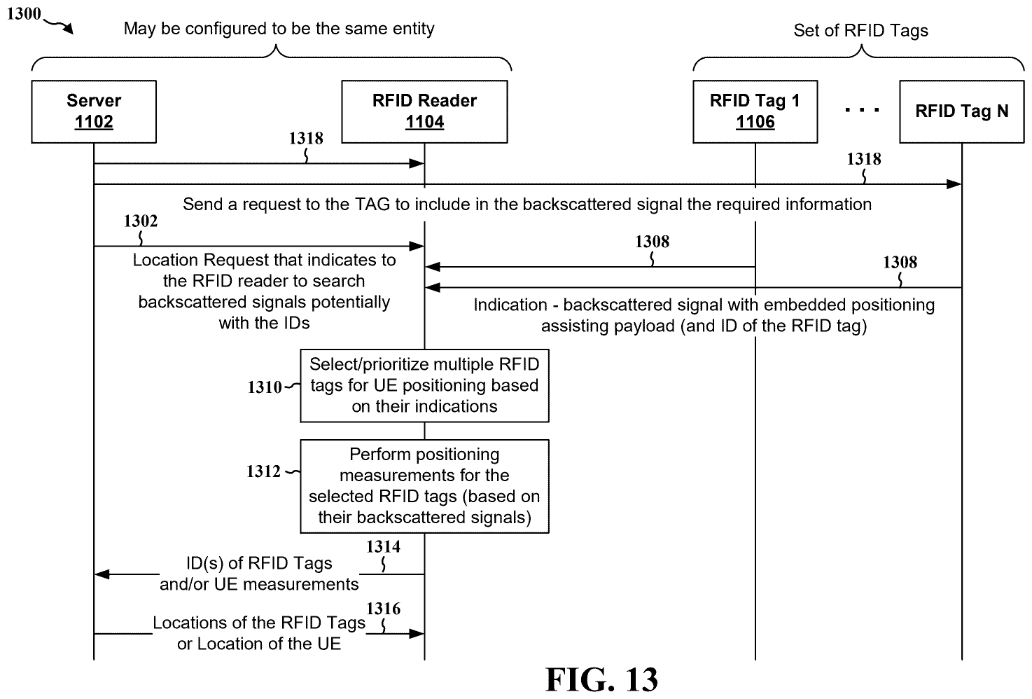

FIG. 13 is a communication flow 1300 illustrating an example signaling between a server, an RFID reader and an RFID tag in accordance with various aspects of the present disclosure. The numberings associated with the communication flow 1300 do not specify a particular temporal order and are merely used as references for the communication flow 1300.

In another configuration, in addition to a network entity sending a request to a set of RFID tags to initiate the procedures described in connection with FIGS. 11 (such as shown at 1318 of FIG. 13 and described in connection with 1218 of FIG. 12), the network entity may also transmit a location request (or an information message) to the RFID reader to inform the RFID reader regarding backscattered signals that may be read by the RFID reader, such as shown at 1302. This location request or information message may also include the time, the frequency, and/or the sequence information associated with indication transmitted from each RFID reader.

Then, at 1308, RFID tags specified by the request from the server 1102, which may include the first RFID tag 1106, may transmit an indication or a tag report to the RFID reader 1104 indicating at least one of: a motion detection indication capability, a positioning change indication, a new location determination capability, positioning information, an updated positioning information, and/or metrics associated with motion detections, such as described in connection with FIGS. 10 to 12.

At 1310, based on the location request from the server and/or the indications from the set of RFID tags, the RFID reader 1104 may select/prioritize a plurality of RFID tags form the set of RFID tags to be used for the UE positioning session, such as based on their capabilities (e.g., obtained from their indications) as described in connection with FIGS. 10 to 12.

At 1312, after determining the plurality of RFID tags to be used for the UE positioning session, the RFID reader 1104 may perform positioning measurements for the selected RFID tags, such as measuring the RTT, the ToA, and/or the AoA of their backscattered signals.

At 1314, for a network-based positioning, the RFID reader 1104 may be configured to transmit the IDs of the plurality of RFID tags, the detected payload/backscattered signals embedded with information received from the plurality of RFID tags, and/or its positioning measurements to the server 1102. Then, at 1316, based on the IDs of the RFID tags, the information in the payload/backscattered signals, and/or the positioning measurements from the RFID reader 1104, the server 1102 may calculate/determine the position of the RFID reader 1104 (or relative position of the RFID reader 1104 with respect to one or more RFID tags), and the server 1102 may indicate the position/relative position of the RFID reader 1104 to the RFID reader 1104.

On the other hand, for a UE-based positioning, at 1314, the RFID reader 1104 may transmit just the IDs collected from the plurality of RFID tags to the server 1102, which may include the first RFID tag 1106. Then, at 1316, in response to the IDs of the plurality of RFID tags, the server 1102 may indicate the locations of the plurality of RFID tags to the RFID reader 1104. Based on the locations of the plurality RFID tags, the information in the payload/backscattered signals received from the plurality of RFID tags, and/or the positioning measurements performed by the RFID reader 1104, the RFID reader 1104 may calculate/determine its position or its position relative to one or more RFID tags.

In another aspect of the present disclosure, other types of IoT devices may also be used for the UE positioning, such as a semi-passive IoT (e.g., an RFID tag with a battery and is able to activate almost all the time but may not transmit actively) and/or a semi-active IoT (e.g., RFID tag with amplification capability and/or active RF components, which may improve quality of reading/writing). Thus, different types of IoT devices may be associated with different antenna configurations (or have different number of antennas), and/or have different processing/measurement capabilities (e.g., positioning information processing capability may be associated with positioning accuracy). As such, an RFID reader may be configured to distinguish between one RFID tag type from another RFID tag type, such that the RFID reader may select/prioritize RFID tags for UE positioning based on their types or based on their hardware specification.

In one example, a positioning measurement rank, which may be used as an indication of measurement accuracy, may be assigned for IoT devices based on their types. In one example, a positioning measurement rank may refer to a rank that is assigned to different types of wireless devices based at least in part on their capabilities, type, or category related to positioning measurement. For example, a first positioning measurement rank may be assigned to passive IoT devices, a second positioning measurement rank may be assigned to semi-passive IoT devices, and a third positioning measurement rank may be assigned to semi-active IoT devices, etc. In another example, the positioning measurement rank may be assigned for IoT devices based on their receiver capabilities to process positioning information/reference signals. For example, a higher positioning measurement rank may be assigned to IoT devices with better capabilities to process positioning information and/or reference signals (e.g., receiving and measuring the reference signals), and a lower positioning measurement rank may be assigned to IoT devices that is unable to process positioning information and/or reference signals with certain thresholds (e.g., within certain time period and/or with certain accuracy). In another example, the positioning measurement rank may be assigned for IoT devices based on their current energy state and/or energy state during processing positioning information and/or reference signals. For example, IoT devices with better energy states (e.g., fast charging, with a battery, etc.) may be given a higher positioning measurement rank, whereas IoT devices without good energy states (e.g., slow charging, no battery, etc.) may be given a lower positioning measurement rank.

The positioning measurement rank associated with each IoT device (e.g., an RFID tag) may be indicated to an RFID reader, such as via a backscattered signal from an RFID tag (e.g., via the indication/tag report described in connection with 1108, 1208, and 1308 of FIGS. 11 to 13) or from a network entity (e.g., via an RFID tag/tag-ID report or based on indicating an RFID tag class that is associated with the RFID tag's type and/or receiver capability to process positioning information/reference signals, etc.). Based on the positioning measurement rank associated with each IoT device, an RFID reader (e.g., the RFID reader 1104) or a network entity (e.g., the server 1102) may select/prioritize a set of RFID tags for performing positioning of a UE based on their corresponding positioning measurement ranks.

In another aspect of the present disclosure, based on the positioning measurement rank associated with each IoT device, different ranks of IoT devices may be configured to transmit different types of indication or tag report. In other words, the type of the indication or tag report from an RFID tag may depend on the RFID tag's positioning measurement rank. For example, IoT devices with a better positioning measurement rank may be specified to transmit more information in the indication/report or more frequently, whereas IoT devices with a lower positioning measurement rank may be specified to transmit less information in the indication/report or less frequently compared to the IoT devices with a higher position measurement rank.

In another aspect of the present disclosure, an RFID reader (e.g., RFID reader 1104) may be configured to collect information from different RFID tags. For example, the RFID reader may request a set of RFID tags to transmit their capability reports to the RFID reader. Based on the capability reports received from the set of RFID tags, the RFID reader may discard some of them (e.g., ones which the RFID reader determine to be not suitable for the UE positioning) before forwarding their tag-IDs and/or collected information to a network entity or a positioning server (e.g., the server 1102). For example, the capability report may include the positioning measurement rank or RFID tag class associated with each RFID tag. As such, the RFID reader may select or remove RFID tags from a UE positioning session based on their corresponding positioning measurement rank or RFID tag class.

In another aspect of the present disclosure, a network entity (e.g., the server 1102, an LMF, a location server, or a base station) may configure an RFID reader (e.g., a UE) with the positioning measurement rank (and also prioritization) of each RFID tag or each tag-ID. For example, a base station may indicate to an RFID reader regarding the positioning measurement rank for each RFID and their priorities. Then, based on the positioning measurement rank and their priorities associated with a set of RFID tags, the RFID reader may perform a prioritization for the set of RFID tags. For example, the RFID reader may be configured to select first five RFID tags from the set of RFID tags with highest priority and/or positioning measurement rank for the UE positioning session, and discard other RFID tags that are not being selected from the UE positioning session. In another example, if the network entity or the RFID reader is able to determine which RFID tags are closer to the RFID reader (e.g., based on RFID tags' latest positioning information available at servers), the network entity may also configure the RFID reader to apply the prioritization for a set of RFID tags based on their distance to the RFID reader. For example, the RFID reader may be configured to select ten RFID tags from a set of RFID tags with closest distances to the RFID reader for the UE positioning session, and discard other RFID tags that are not being selected.

In one example, an RFID reader may be able to figure out how far away is an RFID tag from the RFID reader based on the capability report/indication from the RFID tag and/or based on the RSRP/AoA measurement of the RFID tag (e.g., measurement of the backscattered signal from the RFID tag). Then, the RFID reader may obtain a coarse location of the RFID and identify which frequency, time, and/or power levels are most suitable or likely to occur for a UE positioning session, and the RFID reader may perform a prioritized search for a set of RFID tags accordingly (e.g., searching for RFID tags that are suitable for the identified frequency, time, and/or power levels).

After the RFID reader receives responses (e.g., indications or reports) from a plurality of RFID tags, the RFID reader may perform an additional or a narrower search to determine which of these responded RFID tags are in proximity to the RFID reader. The additional or the narrower search may enable the RFID reader to more accurately determine locations of the RFID tags and/or most suitable RFID tags to be used for localizing the RFID reader itself. In addition, knowing the distance between an RFID tag and the RFID reader may also help the RFID reader to read information from the RFID tag, to send information to the RFID tag, and/or to configure the RFID tag.

As described in connection with FIGS. 11 to 13, in some scenarios, instead of a network entity (e.g., a location server, a base station, etc.) triggering a set of RFID tags to assist a UE positioning session (e.g., to transmit tag reports/indications), an RFID reader (e.g., a UE) may also be configured to trigger the set of RFID tags, such as by transmitting signals (e.g., CWs) to the set of RFID tags with a specified sequence or a password key. For example, a network entity (e.g., the server 1102) may signal to an RFID reader (e.g., the RFID reader 1104), using RRC signaling, a MAC-CE, or a secured channel, a password key for triggering RFID tags on certain zone ID or for triggering RFID tags in proximity to the RFID reader (e.g., based on history of position information).

In one example, the password key may be configured to be RFID tag specific (e.g., each RFID tag is associated with a password key), and the password key may be provided by a network entity or pre-configured at the RFID reader. The password key may be an RFID tag access password (e.g., for accessing the RFID tag), a kill password (e.g., for disabling the RFID tag), or a combination password (e.g., with multiple purposes). In another example, the password key may also be based on a hardware ID associated with an RFID (e.g., may be a permanent unique ID of the RFID tag).

After the RFID tag receives the signaling from an RFID reader with a corresponding password key, the RFID tag may respond in the preconfigured manner until it is reconfigured by a network entity or the RFID reader. For example, the RFID tag may transmit the indication/tag report to the RFID reader based on a correct password key, refrain from transmitting any indication/tag report to the RFID reader based on an incorrect password key, or apply an updated configuration from the RFID reader based on a password key associated with reconfiguration of the RFID tag, etc.

In another example, the password key may also assist the positioning of the RFID reader if the RFID tags are in a gap of coverage. For example, as RFID tags at certain location or zone may be associated with the same password key, the RFID reader may activate RFID tags at different locations or zones based on the corresponding password key.

In another example, resources (e.g., frequency resources) to be used by an RFID tag for transmitting the indication/tag report may be pre-configured for the RFID tag, and an RFID reader (e.g., a requesting UE) may configure the RFID tag with the timing (e.g., the start time) and/or the duration for transmitting the indication/tag report.

In another aspect of the present disclosure, an RFID tag may be configured to announce its ID (e.g., a tag-ID), where the ID may be associated with or connected to a password in a database set. The ID may be permanent and may be used to locate the corresponding password key associated with the RFID tag by a network entity or an authentic device (e.g., an authentic RFID reader) through the database set. For example, the authenticate device may locate the password key associated with an RFID tag in the database set using the corresponding ID of the RFID tag. Then, the RFID reader may send the RFID tag some commands/queries (or writing to tag) to start the process of reading information from the RFID tag using the password key. In some examples, to avoid keep sharing the ID all the time, an RFID tag and the latest RFID reader (e.g., a base station or a UE) may agree on a new RNTI or a temporary ID, where the new RNTI or the temporary ID may be configured to expire when there is a location change for the RFID tag or when a timer associated with the RFID tag expires. Then, a new or updated ID may be requested for the RFID tag. In addition, the new RNTI or the temporary ID may also be used to scramble the data to or from the RFID tag. If the RFID tag is semi-active, the RFID tag may also be configured to send an ID expiry indication to an RFID reader, such as via the position change indication or the tag report.

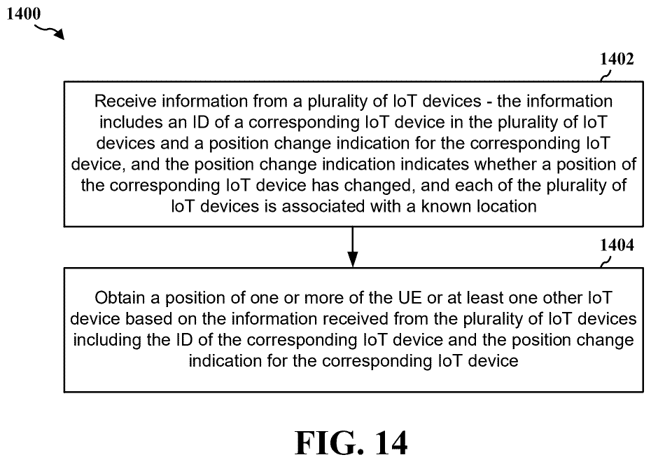

FIG. 14 is a flowchart 1400 of a method of wireless communication. The method may be performed by a UE (e.g., the UE 104, 404, 1002; the RFID reader 604, 1104; the second device 706, 806; the apparatus 1504). The method may enable the UE (e.g., an RFID reader) to determine its position based on a set of IoT devices with known locations.

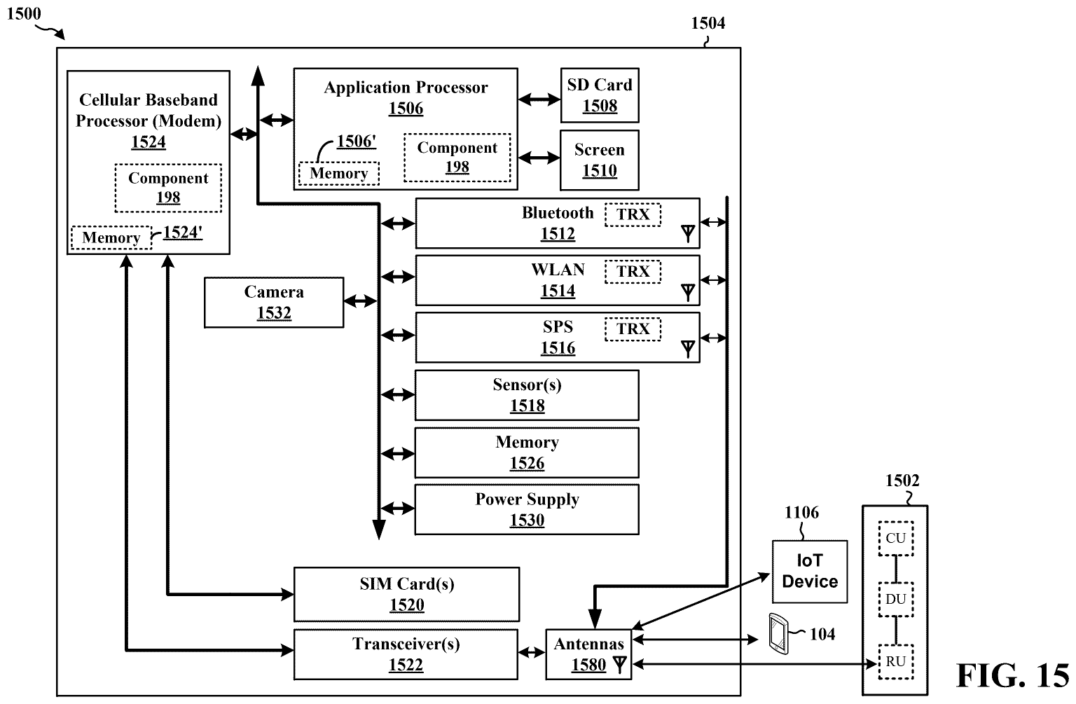

At 1402, the UE may receive information from a plurality of IoT devices, where the information includes an ID of a corresponding IoT device in the plurality of IoT devices and a position change indication for the corresponding IoT device, where the position change indication indicates whether a position of the corresponding IoT device has changed, where each of the plurality of IoT devices is associated with a known location, such as described in connection with FIGS. 10 to 13. For example, at 1108 of FIG. 11, the RFID reader 1104 may receive information from a set of RFID tags, where the information includes an ID of a corresponding RFID tag in the set of RFID tags and a position change indication for the corresponding RFID tag. The reception of information may be performed by, e.g., the RFID reading component 198, the cellular baseband processor 1524, and/or the transceiver(s) 1522 of the apparatus 1504 in FIG. 15.

At 1404, the UE may obtain a position of one or more of the UE or at least one other IoT device based on the information received from the plurality of IoT devices including the ID of the corresponding IoT device and the position change indication for the corresponding IoT device, such as described in connection with FIGS. 10 to 13. For example, at 1116 of FIG. 11, the RFID reader 1104 may obtain its position from the server 1102 or the locations of the RFID tags selected for the UE positioning session. The obtaining of the position of one or more of the UE or at least one other IoT device may be performed by, e.g., the RFID reading component 198, the cellular baseband processor 1524, and/or the transceiver(s) 1522 of the apparatus 1504 in FIG. 15.

In one example, the UE may transmit the information to a network entity, where obtaining the position of the UE may include receiving the position of the UE from the network entity.

In another example, obtaining the position of one or more of the UE or the at least one other IoT device may include calculating a first relative position of the UE with respect to each of the plurality of IoT devices, or calculating a second relative position of the at least one other IoT device with respect to the UE. In such an example, the UE may refrain from including an IoT device in the plurality of IoT devices from the calculation if the position of the IoT device has changed. In such an example, the UE may receive the position change indication from an IoT device in the plurality of IoT devices via the information, and the UE may receive an updated position of the IoT device.

In another example, the UE may receive a location request from a network entity indicating that the plurality of IoT devices is available for obtaining the position of one or more of the UE or the at least one other IoT device, and the UE may monitor for the information transmitted from the plurality of IoT devices based on the location request. In such an example, the location request includes at least one of: a time resource, a frequency resource, or a sequence associated with the plurality of IoT devices.

In another example, the position change indication corresponds to at least one motion detection metric associated with the corresponding IoT device, and the UE may determine whether the position of the corresponding IoT device has changed based on the at least one motion detection metric.

In another example, the UE may transmit at least one signal to the plurality of IoT devices prior to receiving the information from the plurality of IoT devices, where the information is received in a format derived based on the at least one signal.

In another example, each of the plurality of IoT devices is associated with a positioning measurement rank, and the UE may prioritize the information received from a first IoT device in the plurality of IoT devices that is associated with a first positioning measurement rank, or the UE may deprioritize or exclude the information received from a second IoT device in the plurality of IoT devices that is associated with a second positioning measurement rank, where the first positioning measurement rank is higher than the second positioning measurement rank. In such an example, the positioning measurement rank is based on at least one of: an IoT device type, an IoT device capability, a current energy state of the corresponding IoT device, or an energy state of the corresponding IoT device during processing. In such an example, the UE may transmit the positioning measurement rank associated with the plurality of IoT devices to a network entity, or receive the positioning measurement rank associated with the plurality of IoT devices from the network entity. In such an example, the UE may determine the positioning measurement rank associated with the plurality of IoT devices based on one or more measurements associated with the plurality of IoT devices.

In another example, the UE may receive at least one password key associated with the plurality of IoT devices, and the UE may trigger the plurality of IoT devices to transmit the information based on the at least one password key.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the RFID reading component 198 is configured to receive information from a plurality of IoT devices, where the information includes an ID of a corresponding IoT device in the plurality of IoT devices and a position change indication for the corresponding IoT device, where the position change indication indicates whether a position of the corresponding IoT device has changed, where each of the plurality of IoT devices is associated with a known location. The RFID reading component 198 may also be configured to obtain a position of one or more of the UE or at least one other IoT device based on the information received from the plurality of IoT devices including the ID of the corresponding IoT device and the position change indication for the corresponding IoT device. The RFID reading component 198 may be within the cellular baseband processor 1524, the application processor 1506, or both the cellular baseband processor 1524 and the application processor 1506. The RFID reading component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for receiving information from a plurality of IoT devices, where the information includes an ID of a corresponding IoT device in the plurality of IoT devices and a position change indication for the corresponding IoT device, where the position change indication indicates whether a position of the corresponding IoT device has changed, where each of the plurality of IoT devices is associated with a known location. The apparatus 1504 may further include means for obtaining a position of one or more of the UE or at least one other IoT device based on the information received from the plurality of IoT devices including the ID of the corresponding IoT device and the position change indication for the corresponding IoT device.

In one configuration, the apparatus 1504 may further include means for transmitting the information to a network entity, where obtaining the position of the UE may include receiving the position of the UE from the network entity.

In another configuration, the means for obtaining the position of one or more of the UE or the at least one other IoT device may include configuring the apparatus 1504 to calculate a first relative position of the UE with respect to each of the plurality of IoT devices, or calculating a second relative position of the at least one other IoT device with respect to the UE. In such a configuration, the apparatus 1504 may further include means for refraining from including an IoT device in the plurality of IoT devices from the calculation if the position of the IoT device has changed. In such a configuration, the apparatus 1504 may further include means for receiving the position change indication from an IoT device in the plurality of IoT devices via the information, and means for receiving an updated position of the IoT device.

In another configuration, the apparatus 1504 may further include means for receiving a location request from a network entity indicating that the plurality of IoT devices is available for obtaining the position of one or more of the UE or the at least one other IoT device, and means for monitoring for the information transmitted from the plurality of IoT devices based on the location request. In such a configuration, the location request includes at least one of: a time resource, a frequency resource, or a sequence associated with the plurality of IoT devices.

In another configuration, the position change indication corresponds to at least one motion detection metric associated with the corresponding IoT device, and the apparatus 1504 may further include means for determining whether the position of the corresponding IoT device has changed based on the at least one motion detection metric.

In another configuration, the apparatus 1504 may further include means for transmitting at least one signal to the plurality of IoT devices prior to receiving the information from the plurality of IoT devices, where the information is received in a format derived based on the at least one signal.

In another configuration, each of the plurality of IoT devices is associated with a positioning measurement rank, and the apparatus 1504 may further include means for prioritizing the information received from a first IoT device in the plurality of IoT devices that is associated with a first positioning measurement rank, or means for deprioritizing or excluding the information received from a second IoT device in the plurality of IoT devices that is associated with a second positioning measurement rank, where the first positioning measurement rank is higher than the second positioning measurement rank. In such a configuration, the positioning measurement rank is based on at least one of: an IoT device type, an IoT device capability, a current energy state of the corresponding IoT device, or an energy state of the corresponding IoT device during processing. In such a configuration, the apparatus 1504 may further include means for transmitting the positioning measurement rank associated with the plurality of IoT devices to a network entity, or means for receiving the positioning measurement rank associated with the plurality of IoT devices from the network entity. In such a configuration, the apparatus 1504 may further include means for determining the positioning measurement rank associated with the plurality of IoT devices based on one or more measurements associated with the plurality of IoT devices.

In another configuration, the apparatus 1504 may further include means for receiving at least one password key associated with the plurality of IoT devices, and means for triggering the plurality of IoT devices to transmit the information based on the at least one password key.

The means may be the RFID reading component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

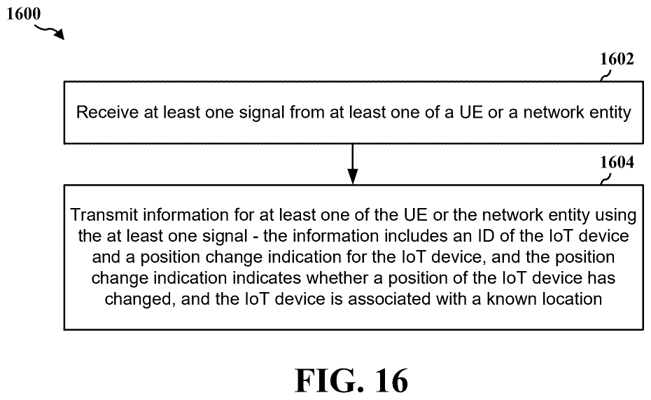

FIG. 16 is a flowchart 1600 of a method of wireless communication. The method may be performed by an IoT device (e.g., the passive IoT device 502, 602; the active IoT device 510; the RFID tag 704, 804, 1004, 1006, 1008, 1010, 1012, 1106; the apparatus 1704). The method may enable the IoT device to indicate to an RFID reader whether its position has changed and/or its new/updated position if its position has changed.

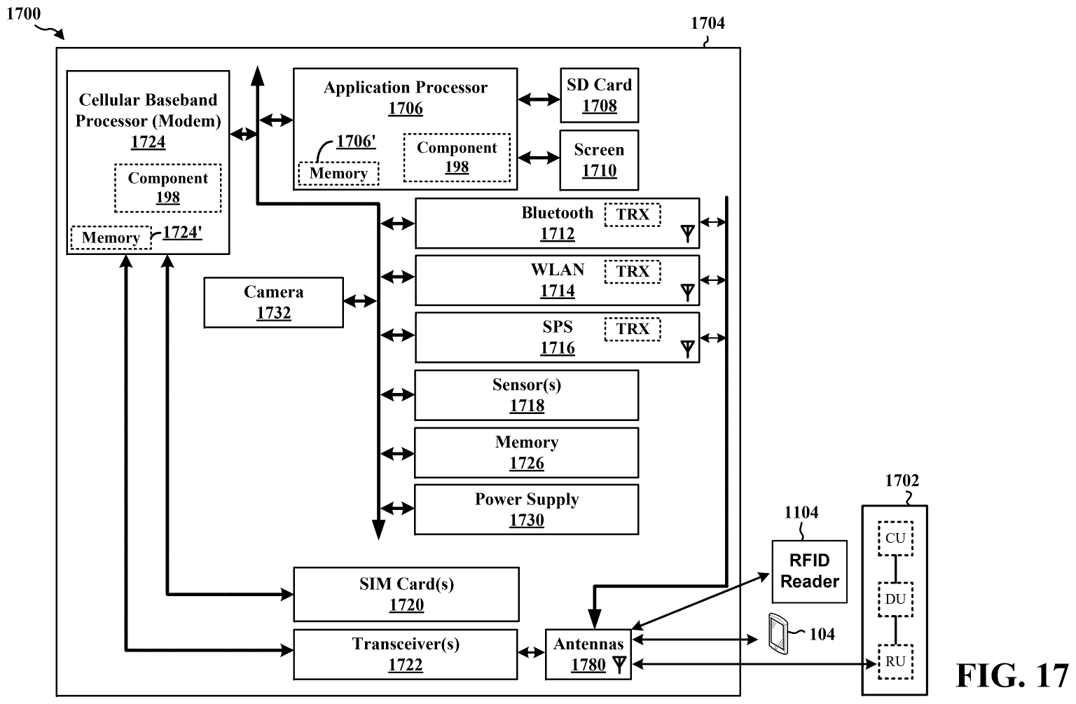

At 1602, the IoT may receive at least one signal from at least one of a UE or a network entity, such as described in connection with FIGS. 6, 7, 8A, and 8B. For example, as shown by FIG. 8A, the RFID tag 804 may receive signal from a first device 802, which may be a UE or a network entity. The reception of the at least one signal may be performed by, e.g., the backscattering component 197, the cellular baseband processor 1724, and/or the transceiver(s) 1722 of the apparatus 1704 in FIG. 17.

At 1604, the IoT may transmit information for at least one of the UE or the network entity using the at least one signal, where the information includes an ID of the IoT device and a position change indication for the IoT device, where the position change indication indicates whether a position of the IoT device has changed, where the IoT device is associated with a known location, such as described in connection with FIGS. 10 to 13. For example, as shown at 1108 of FIG. 11, the first RFID tag 1106 may transmit an indication to the RFID reader 1104, where the indication may include its tag ID and whether its position has changed. The transmission of the information may be performed by, e.g., the backscattering component 197, the cellular baseband processor 1724, and/or the transceiver(s) 1722 of the apparatus 1704 in FIG. 17.

In one example, the IoT device may determine whether the position of the IoT device has changed based on at least one motion sensor or based on a comparison of a current location of the IoT device with a last read location of the IoT device. In such an example, the IoT device may transmit an updated position of the IoT device if the position of the IoT device has changed.

In another example, the IoT device may receive a request from at least one of the UE or the network entity to transmit the information, where the request includes at least one parameter associated with the information, and the IoT device may transmit the information based on the request. In such an example, the request includes at least one of: a time resource for transmitting the information, a frequency resource for transmitting the information, a sequence for transmitting the information, a timing information for transmitting the information, a duration for transmitting the information, or a zone-ID, a tag-ID, or a location ID to be included in the information. In another example, the position change indication corresponds to at least one motion detection metric, and the IoT device may determine the at least one motion detection metric via at least one motion sensor.

In another example, the information further includes a positioning measurement rank associated with the IoT device.

In another example, the IoT device may receive a password key associated with the IoT device from at least one of the UE or the network entity in the at least one signal, and the IoT device may transmit the information in response to the password key being authentic.

In another example, the information is transmitted in a format derived based on the at least one signal.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the backscattering component 197 is configured to receive at least one signal from at least one of a UE or a network entity. The backscattering component 197 may also be configured to transmit information for at least one of the UE or the network entity using the at least one signal, where the information includes an ID of the IoT device and a position change indication for the IoT device, where the position change indication indicates whether a position of the IoT device has changed, where the IoT device is associated with a known location. The backscattering component 197 may be within the cellular baseband processor 1724, the application processor 1706, or both the cellular baseband processor 1724 and the application processor 1706. The backscattering component 197 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for receiving at least one signal from at least one of a UE or a network entity. The apparatus 1704 may further include means for transmitting information for at least one of the UE or the network entity using the at least one signal, where the information includes an ID of the IoT device and a position change indication for the IoT device, where the position change indication indicates whether a position of the IoT device has changed, where the IoT device is associated with a known location.

In one configuration, the apparatus 1704 may further include means for determining whether the position of the IoT device has changed based on at least one motion sensor or based on a comparison of a current location of the IoT device with a last read location of the IoT device. In such a configuration, the apparatus 1704 may further include means for transmitting an updated position of the IoT device if the position of the IoT device has changed.

In another configuration, the apparatus 1704 may further include means for receiving a request from at least one of the UE or the network entity to transmit the information, where the request includes at least one parameter associated with the information, and the IoT device may transmit the information based on the request. In such a configuration, the request includes at least one of: a time resource for transmitting the information, a frequency resource for transmitting the information, a sequence for transmitting the information, a timing information for transmitting the information, a duration for transmitting the information, or a zone-ID, a tag-ID, or a location ID to be included in the information.

In another configuration, the position change indication corresponds to at least one motion detection metric, and the apparatus 1704 may further include means for determining the at least one motion detection metric via at least one motion sensor.

In another configuration, the information further includes a positioning measurement rank associated with the IoT device.

In another configuration, the apparatus 1704 may further include means for receiving a password key associated with the IoT device from at least one of the UE or the network entity in the at least one signal, and means for transmitting the information in response to the password key being authentic.

In another configuration, the information is transmitted in a format derived based on the at least one signal.

The means may be the backscattering component 197 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

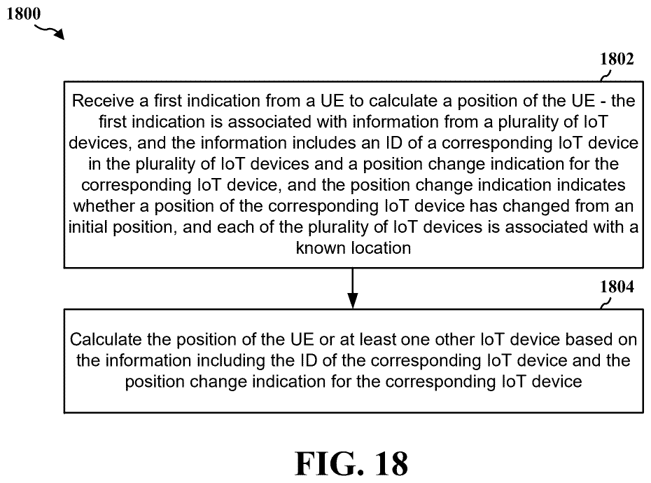

FIG. 18 is a flowchart 1800 of a method of wireless communication. The method may be performed by a base station (e.g., the base station 102; the server 1102; the network entity 1902. The method may enable the base station to determine the position of a UE or for a set of IoT devices.

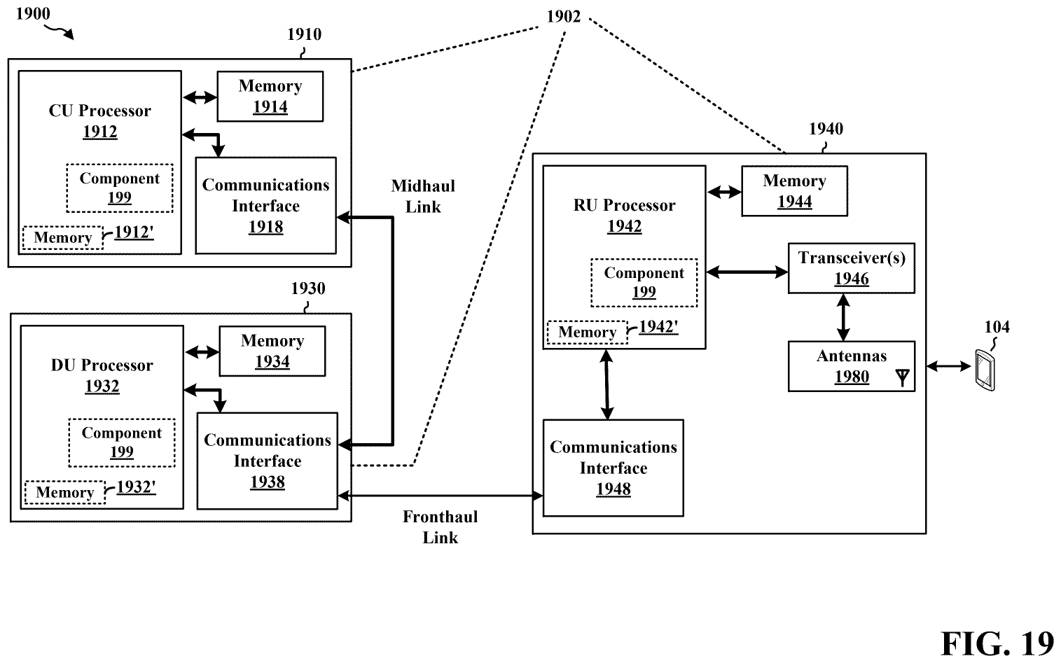

At 1802, the base station may receive a first indication from a UE to calculate a position of the UE, where the first indication is associated with information from a plurality of IoT devices, where the information includes an ID of a corresponding IoT device in the plurality of IoT devices and a position change indication for the corresponding IoT device, where the position change indication indicates whether a position of the corresponding IoT device has changed from an initial position, where each of the plurality of IoT devices is associated with a known location, such as described in connection with FIGS. 11 to 13. For example, as shown at 1114 of FIG. 11, the server 1102 may receive the IDs of the plurality of RFID tags, information in the payload/backscattered signals, and/or positioning measurements from the RFID reader 1104. Based on the IDs of the RFID tags, the information in the payload/backscattered signals, and/or the positioning measurements from the RFID reader 1104, the server 1102 may calculate/determine the position of the RFID reader 1104 (or relative position of the RFID reader 1104 with respect to one or more RFID tags). The reception of the first indication may be performed by, e.g., the UE positioning component 199 and/or the transceiver(s) 1946 of the network entity 1902 in FIG. 19.

At 1804, the base station may calculate the position of the UE or at least one other IoT device based on the information including the ID of the corresponding IoT device and the position change indication for the corresponding IoT device, such as described in connection with FIGS. 11 to 13. For example, as discussed in connection with FIG. 11, based on the IDs of the RFID tags, the information in the payload/backscattered signals, and/or the positioning measurements from the RFID reader 1104, the server 1102 may calculate/determine the position of the RFID reader 1104 (or relative position of the RFID reader 1104 with respect to one or more RFID tags). The calculation of the position of the UE or at least one other IoT device may be performed by, e.g., the UE positioning component 199 and/or the transceiver(s) 1946 of the network entity 1902 in FIG. 19.

In one example, the base station may transmit at least one signal for the plurality of IoT devices.

In another example, the base station may receive a request from the UE to perform a location calculation for the UE, and the base station may transmit a second indication of the position of the UE for the UE based on the request.

In another example, the base station may transmit a positioning measurement rank associated with each of the plurality of IoT devices for the UE or the corresponding IoT device.

In another example, the base station may transmit a location request for the UE indicating that the plurality of IoT devices is available for calculating the position of UE, or transmit a second request for the plurality of IoT devices to transmit the information, where the location request or the second request includes at least one parameter associated with the information. In such an example, the base station may determine the plurality of IoT devices that are available for calculating the position of the UE based on crowdsourcing information or past UE reporting.

In another example, the base station may transmit at least one password key associated with the plurality of IoT devices to the UE.

In another example, the base station may store the position of the UE or the at least one other IoT device in a database, where the stored position of the UE or the at least one other IoT device is used for determining a second position of the UE or the at least one other IoT device at a subsequent time.

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the UE positioning component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the UE positioning component 199 is configured to receive a first indication from a UE to calculate a position of the UE, where the first indication is associated with information from a plurality of IoT devices, where the information includes an ID of a corresponding IoT device in the plurality of IoT devices and a position change indication for the corresponding IoT device, where the position change indication indicates whether a position of the corresponding IoT device has changed from an initial position, where each of the plurality of IoT devices is associated with a known location. The UE positioning component 199 may also be configured to calculate the position of the UE or at least one other IoT device based on the information including the ID of the corresponding IoT device and the position change indication for the corresponding IoT device. The UE positioning component 199 may be within one or more processors of one or more of the CU 1910, DU 1930, and the RU 1940. The UE positioning component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 includes means for receiving a first indication from a UE to calculate a position of the UE, where the first indication is associated with information from a plurality of IoT devices, where the information includes an ID of a corresponding IoT device in the plurality of IoT devices and a position change indication for the corresponding IoT device, where the position change indication indicates whether a position of the corresponding IoT device has changed from an initial position, where each of the plurality of IoT devices is associated with a known location. The network entity 1902 may further include means for calculating the position of the UE or at least one other IoT device based on the information including the ID of the corresponding IoT device and the position change indication for the corresponding IoT device.

In one configuration, the network entity 1902 may further include means for transmitting at least one signal for the plurality of IoT devices.

In another configuration, the network entity 1902 may further include means for receiving a request from the UE to perform a location calculation for the UE, and means for transmitting a second indication of the position of the UE for the UE based on the request.

In another configuration, the network entity 1902 may further include means for transmitting a positioning measurement rank associated with each of the plurality of IoT devices for the UE or the corresponding IoT device.

In another configuration, the network entity 1902 may further include means for transmitting a location request for the UE indicating that the plurality of IoT devices is available for calculating the position of UE, or transmit a second request for the plurality of IoT devices to transmit the information, where the location request or the second request includes at least one parameter associated with the information. In such a configuration, the network entity 1902 may further include means for determining the plurality of IoT devices that are available for calculating the position of the UE based on crowdsourcing information or past UE reporting.

In another configuration, the base station may transmit at least one password key associated with the plurality of IoT devices to the UE.

In another configuration, the network entity 1902 may further include means for storing the position of the UE or the at least one other IoT device in a database, where the stored position of the UE or the at least one other IoT device is used for determining a second position of the UE or the at least one other IoT device at a subsequent time.

The means may be the UE positioning component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE, including: receiving information from a plurality of IoT devices, where the information includes an ID of a corresponding IoT device in the plurality of IoT devices and a position change indication for the corresponding IoT device, where the position change indication indicates whether a position of the corresponding IoT device has changed, where each of the plurality of IoT devices is associated with a known location; and obtaining a position of one or more of the UE or at least one other IoT device based on the information received from the plurality of IoT devices including the ID of the corresponding IoT device and the position change indication for the corresponding IoT device.

Aspect 2 is the method of aspect 1, further including: transmitting the information to a network entity; where obtaining the position of the UE includes: receiving the position of the plurality of IoT devices from the network entity.

Aspect 3 is the method of aspect 1 or 2, where obtaining the position of one or more of the UE or the at least one other IoT device includes: calculating a first relative position of the UE with respect to each of the plurality of IoT devices, or calculating a second relative position of the at least one other IoT device with respect to the UE.

Aspect 4 is the method of aspect 3, further including: refraining from including an IoT device in the plurality of IoT devices from the calculation if the position of the IoT device has changed.

Aspect 5 is the method of aspect 3, further including: receiving the position change indication from an IoT device in the plurality of IoT devices via the information; and receiving an updated position of the IoT device.

Aspect 6 is the method of any of aspects 1 to 5, further including: receiving a location request from a network entity indicating that the plurality of IoT devices is available for obtaining the position of one or more of the UE or the at least one other IoT device; and monitoring for the information transmitted from the plurality of IoT devices based on the location request.

Aspect 7 is the method of aspect 6, where the location request includes at least one of: a time resource, a frequency resource, or a sequence associated with the plurality of IoT devices.

Aspect 8 is the method of any of aspects 1 to 7, where the position change indication corresponds to at least one motion detection metric associated with the corresponding IoT device, the method further including: determining whether the position of the corresponding IoT device has changed based on the at least one motion detection metric.

Aspect 9 is the method of any of aspects 1 to 8, further including: transmitting at least one signal to the plurality of IoT devices prior to receiving the information from the plurality of IoT devices, where the information is received in a format derived based on the at least one signal.

Aspect 10 is the method of any of aspects 1 to 9, where each of the plurality of IoT devices is associated with a positioning measurement rank, further including: prioritizing the information received from a first IoT device in the plurality of IoT devices that is associated with a first positioning measurement rank; or deprioritizing or excluding the information received from a second IoT device in the plurality of IoT devices that is associated with a second positioning measurement rank, where the first positioning measurement rank is higher than the second positioning measurement rank.

Aspect 11 is the method of aspect 10, where the positioning measurement rank is based on at least one of: an IoT device type, an IoT device capability, a current energy state of the corresponding IoT device, or an energy state of the corresponding IoT device during processing.

Aspect 12 is the method of aspect 10, further including: transmitting the positioning measurement rank associated with the plurality of IoT devices to a network entity, or receiving the positioning measurement rank associated with the plurality of IoT devices from the network entity.

Aspect 13 is the method of aspect 10, further including: determining the positioning measurement rank associated with the plurality of IoT devices based on one or more measurements associated with the plurality of IoT devices.

Aspect 14 is the method of aspect 12, further including: receiving at least one password key associated with the plurality of IoT devices; and triggering the plurality of IoT devices to transmit the information based on the at least one password key.

Aspect 15 is an apparatus for wireless communication at a UE, including: a memory; and at least one processor coupled to the memory and, based at least in part on information stored in the memory, the at least one processor is configured to implement any of aspects 1 to 14.

Aspect 16 is the apparatus of aspect 15, further including at least one of a transceiver or an antenna coupled to the at least one processor.

Aspect 17 is an apparatus for wireless communication including means for implementing any of aspects 1 to 14.

Aspect 18 is a computer-readable medium (e.g., a non-transitory computer-readable medium) storing computer executable code, where the code when executed by a processor causes the processor to implement any of aspects 1 to 14.

Aspect 19 is a method of wireless communication at an IoT device, including: receiving at least one signal from at least one of a UE or a network entity; and transmitting information for at least one of the UE or the network entity using the at least one signal, where the information includes an ID of the IoT device and a position change indication for the IoT device, where the position change indication indicates whether a position of the IoT device has changed, where the IoT device is associated with a known location.

Aspect 20 is the method of aspect 19, further including: determining whether the position of the IoT device has changed based on at least one motion sensor or based on a comparison of a current location of the IoT device with a last read location of the IoT device.

Aspect 21 is the method of aspect 20, further including: transmitting an updated position of the IoT device if the position of the IoT device has changed.

Aspect 22 is the method of any of aspects 19 to 21, further including: receiving a request from at least one of the UE or the network entity to transmit the information, where the request includes at least one parameter associated with the information; and transmitting the information based on the request.

Aspect 23 is the method of any of aspect 22, where the request includes at least one of: a time resource for transmitting the information, a frequency resource for transmitting the information, a sequence for transmitting the information, a timing information for transmitting the information, a duration for transmitting the information, or a zone-ID, a tag-ID, or a location ID to be included in the information.

Aspect 24 is the method of any of aspects 19 to 23, where the position change indication corresponds to at least one motion detection metric, the method further including: determining the at least one motion detection metric via at least one motion sensor.

Aspect 25 is the method of any of aspects 19 to 24, where the information further includes a positioning measurement rank associated with the IoT device.

Aspect 26 is the method of any of aspects 19 to 25, further including: receiving a password key associated with the IoT device from at least one of the UE or the network entity in the at least one signal; and transmitting the information in response to the password key being authentic.

Aspect 27 is the method of any of aspects 19 to 26, where the information is transmitted in a format derived based on the at least one signal.

Aspect 28 is an apparatus for wireless communication at an IoT device, including: a memory; and at least one processor coupled to the memory and, based at least in part on information stored in the memory, the at least one processor is configured to implement any of aspects 19 to 27.

Aspect 29 is the apparatus of aspect 28, further including at least one of a transceiver or an antenna coupled to the at least one processor.

Aspect 30 is an apparatus for wireless communication including means for implementing any of aspects 19 to 27.

Aspect 31 is a computer-readable medium (e.g., a non-transitory computer-readable medium) storing computer executable code, where the code when executed by a processor causes the processor to implement any of aspects 19 to 27.

Aspect 32 is a method of wireless communication at a network entity, including: receiving a first indication from a UE to calculate a position of the UE, where the first indication is associated with information from a plurality of IoT devices, where the information includes an ID of a corresponding IoT device in the plurality of IoT devices and a position change indication for the corresponding IoT device, where the position change indication indicates whether a position of the corresponding IoT device has changed from an initial position, where each of the plurality of IoT devices is associated with a known location; and calculating the position of the UE or at least one other IoT device based on the information including the ID of the corresponding IoT device and the position change indication for the corresponding IoT device.

Aspect 33 is the method of aspect 32, further including: transmitting at least one signal for the plurality of IoT devices.

Aspect 34 is the method of aspect 32 or aspect 33, further including: receiving a request from the UE to perform a location calculation for the UE; and transmitting a second indication of the position of the UE for the UE based on the request.

Aspect 35 is the method of any of aspects 32 to 34, further including: transmitting a positioning measurement rank associated with each of the plurality of IoT devices for the UE or the corresponding IoT device.

Aspect 36 is the method of any of aspects 32 to 35, further including: transmitting a location request for the UE indicating that the plurality of IoT devices is available for calculating the position of UE, or transmitting a second request for the plurality of IoT devices to transmit the information, where the location request or the second request includes at least one parameter associated with the information.

Aspect 37 is the method of aspect 36, further including: determining the plurality of IoT devices that are available for calculating the position of the UE based on crowdsourcing information or past UE reporting.

Aspect 38 is the method of any of aspects 32 to 37, further including: transmitting at least one password key associated with the plurality of IoT devices to the UE.

Aspect 39 is the method of any of aspects 32 to 38, further including: storing the position of the UE or the at least one other IoT device in a database, where the stored position of the UE or the at least one other IoT device is used for determining a second position of the UE or the at least one other IoT device at a subsequent time.

Aspect 40 is an apparatus for wireless communication at a network entity, including: a memory; and at least one processor coupled to the memory and, based at least in part on information stored in the memory, the at least one processor is configured to implement any of aspects 32 to 39.

Aspect 41 is the apparatus of aspect 40, further including at least one of a transceiver or an antenna coupled to the at least one processor.

Aspect 42 is an apparatus for wireless communication including means for implementing any of aspects 32 to 39.

Aspect 43 is a computer-readable medium (e.g., a non-transitory computer-readable medium) storing computer executable code, where the code when executed by a processor causes the processor to implement any of aspects 32 to 39.

1. An apparatus for wireless communication at a user equipment (UE), comprising:
a memory; and
at least one processor coupled to the memory and, based at least in part on first information stored in the memory, the at least one processor is configured to:
receive information from a plurality of Internet of Things (loT) devices, wherein the information includes an identification (ID) of a corresponding loT device in the plurality of loT devices and a position change indication for the corresponding loT device, wherein the position change indication indicates whether a position of the corresponding loT device has changed, wherein each of the plurality of loT devices is associated with a known location; and obtain a position of one or more of the UE or at least one other loT device based on the information received from the plurality of loT devices including the ID of the corresponding loT device and the position change indication for the corresponding loT device.

2. The apparatus of claim 1, wherein the at least one processor is further configured to: transmit the information to a network entity;
wherein to obtain the position of the UE the at least one processor is configured to receive the position of the plurality of loT devices from the network entity.

3. The apparatus of claim 1, wherein to obtain the position of one or more of the UE or the at least one other loT device, the at least one processor is configured to:
calculate a first relative position of the UE with respect to each of the plurality of loT devices, or
calculate a second relative position of the at least one other loT device with respect to the UE.

4. The apparatus of claim 3, wherein the at least one processor is further configured to: refrain from including an loT device in the plurality of loT devices from the calculation if the position of the loT device has changed.

5. (canceled)

6. The apparatus of claim 1, wherein the at least one processor is further configured to:
receive a location request from a network entity indicating that the plurality of loT devices is available for obtaining the position of one or more of the UE or the at least one other loT device; and
monitor for the information transmitted from the plurality of loT devices based on the location request.

7. The apparatus of claim 6, wherein the location request includes at least one of: a time resource, a frequency resource, or a sequence associated with the plurality of loT devices.

8. (canceled)

9. The apparatus of claim 1, wherein the at least one processor is further configured to:
transmit at least one signal to the plurality of loT devices prior to receiving the information from the plurality of loT devices, wherein to receive the information from the plurality of loT devices, the at least one processor is configured to receive the information in a format derived based on the at least one signal.

10. The apparatus of claim 1, wherein each of the plurality of loT devices is associated with a positioning measurement rank, and the at least one processor is further configured to:
prioritize the information received from a first loT device in the plurality of loT devices that is associated with a first positioning measurement rank; or
deprioritize or exclude the information received from a second loT device in the plurality of loT devices that is associated with a second positioning measurement rank, wherein the first positioning measurement rank is higher than the second positioning measurement rank.

11. The apparatus of claim 10, wherein the positioning measurement rank is based on at least one of:
an loT device type,
an loT device capability,
a current energy state of the corresponding loT device, or
an energy state of the corresponding loT device during processing.

12. The apparatus of claim 10, wherein the at least one processor is further configured to:
transmit the positioning measurement rank associated with the plurality of loT devices to a network entity, or
receive the positioning measurement rank associated with the plurality of loT devices from the network entity.

13. (canceled)

14. The apparatus of claim 1, wherein the at least one processor is further configured to:
receive at least one password key associated with the plurality of loT devices; and trigger the plurality of loT devices to transmit the information based on the at least one password key.

15. (canceled)

16. An apparatus for wireless communication at an Internet of Things (loT) device, comprising:
a memory; and
at least one processor coupled to the memory and, based at least in part on first information stored in the memory, the at least one processor is configured to:
receive at least one signal from at least one of a user equipment (UE) or a network entity; and
transmit information for at least one of the UE or the network entity using the at least one signal, wherein the information includes an identification (ID) of the loT device and a position change indication for the loT device, wherein the position change indication indicates whether a position of the loT device has changed, wherein the loT device is associated with a known location.

17. (canceled)

18. (canceled)

19. The apparatus of claim 16, wherein the at least one processor is further configured to:
receive a request from at least one of the UE or the network entity to transmit the information, wherein the request includes at least one parameter associated with the information; and
transmit the information based on the request.

20. The apparatus of claim 19, wherein the request includes at least one of:
a time resource for transmitting the information,
a frequency resource for transmitting the information,
a sequence for transmitting the information,
a timing information for transmitting the information,
a duration for transmitting the information, or
a zone-ID, a tag-ID, or a location ID to be included in the information.

21. (canceled)

22. (canceled)

23. The apparatus of claim 16, wherein the at least one processor is further configured to:
receive a password key associated with the loT device from at least one of the UE or the network entity in the at least one signal; and
transmit the information in response to the password key being authentic.

24. (canceled)

25. An apparatus for wireless communication at a network entity, comprising:
a memory; and
at least one processor coupled to the memory and, based at least in part on first information stored in the memory, the at least one processor is configured to:
receive a first indication from a user equipment (UE) to calculate a position of the UE, wherein the first indication is associated with information from a plurality of Internet of Things (loT) devices, wherein the information includes an identification (ID) of a corresponding loT device in the plurality of loT devices and a position change indication for the corresponding loT device, wherein the position change indication indicates whether a position of the corresponding loT device has changed from an initial position, wherein each of the plurality of loT devices is associated with a known location; and calculate the position of the UE or at least one other loT device based on the information including the ID of the corresponding loT device and the position change indication for the corresponding loT device.

26. (canceled)

27. (canceled)

28. The apparatus of claim 25, wherein the at least one processor is further configured to:
transmit a positioning measurement rank associated with each of the plurality of loT devices for the UE or the corresponding loT device.

29. The apparatus of claim 25, wherein the at least one processor is further configured to:
transmit a location request for the UE indicating that the plurality of loT devices is available for calculating the position of UE, or transmitting a second request for the plurality of loT devices to transmit the information, wherein the location request or the second request includes at least one parameter associated with the information; and determine the plurality of loT devices that are available for calculating the position of the UE based on crowdsourcing information or past UE reporting.

30. The apparatus of claim 25, wherein the at least one processor is further configured to:
transmit at least one password key associated with the plurality of loT devices to the UE.
